(19) United States
(12) Patent Application Publication
(10) Pub. No.: US 2012/0213967 A1
(43) Pub. Date: Aug. 23, 2012

(54) OPTICAL LAMINATE FILM AND DISPLAY DEVICE

(76) Inventors: Hidemasa HOSODA, Minami-Ashigara-shi (JP); Tatsuya Nomura, Minami-Ashigara-shi (JP); Takashi Kobayashi, Minami-Ashigara-shi (JP)

(21) Appl. No.: 13/402,332

(22) Filed: Feb. 22, 2012

(30) Foreign Application Priority Data
Feb. 23, 2011 (JP) 2011-037568
Mar. 30, 2011 (JP) 2011-075923
Aug. 19, 2011 (JP) 2011-179830

(51) Int. Cl. B32B 5/16

(52) U.S. Cl. 428/143; 428/336

(57) ABSTRACT

A stably-manufacturable optical laminate film and display device without rainbow-like unevenness are provided. An optical laminate film comprising: a support; an easily-adhesive layer provided on one surface of the support; and a transparent layer made of translucent resin provided on another surface of the support, wherein the transparent layer contains translucent particles, a volume average particle diameter r of the translucent particles satisfies 0.4 μm≦r≦3.0 μm, a total sum S of the translucent particles satisfies 30 mg/m²≦S≦500 mg/m², and an average film thickness t of the transparent layer satisfies r/4≦t<r.

### BACKGROUND OF THE INVENTION

1. Field of the Invention

The present invention relates to optical laminate films and display devices and, in particular, to an optical laminate film and display device suitably used as a member of a backlight unit of a liquid-crystal display.

2. Description of the Related Art

An optical laminate film such as a prism sheet, a lens sheet, and a diffusion sheet is widely used as a member of a backlight unit of a flat panel display (such as TV or a monitor). The optical laminate film includes a support and many sheets such as a prism sheet and lens sheet refracting incident light in a predetermined direction and a diffusion sheet variously refracting incident light for diffusion. Japanese Patent Application Laid-Open No. 2009-175646 discloses an optical laminate film with an upper diffusion sheet arranged on a lens sheet.

In the recent years, for the purpose of reducing the number of components and cost, an optical laminate film without an upper diffusion sheet arranged on a prism sheet has been considered.

For example, Japanese National Publication of International Patent Application No. 2001-524225 discloses an optical laminate film including a prism sheet arranged on one surface of a support and a resin layer containing particles arranged on the other surface of the support. In this gazette, by setting a haze value equal to or higher than 20% and equal to or lower than 60%, scratches, white spots, stains, and others are hidden. In Japanese Patent Application Laid-Open No. 2002-243920, by controlling a convex height by particles, scratches and luminance unevenness are resolved.

### SUMMARY OF THE INVENTION

Since the optical laminate film described in National Publication of International Patent Application No. 2001-524225 does not include an upper diffusion sheet, it is advantageous in the number of components and cost reduction. However, it has been found that, in a backlight unit for use in a flat panel display, if an optical laminate film where a prism sheet is present on a top layer is used, rainbow-colored unevenness (rainbow-like unevenness) disadvantageously appears when viewed from a diagonal direction of the prism sheet.

This rainbow-like unevenness is different from conventionally-thought unevenness occurring due to interference by film lamination, and is caused by chromatic dispersion in refractive index of the resin itself of the prism sheet. Moreover, since it is difficult to obtain a prism-dedicated resin without chromatic dispersion in refractive index, rainbow-like unevenness is fundamentally problematic.

As a result of diligent studies by the inventors, it has been found that for stable production without rainbow-like unevenness, a volume average particle diameter of particles, an addition amount of particles, and a relation between the volume average particle diameter and an average film thickness of a transparent layer satisfy a predetermined relation or the volume average particle diameter of particles, the addition amount of particles, and a 10-point average roughness Rz of a transparent layer satisfy a predetermined relation, thereby solving these problems.

An object of the present invention is to provide a stably-manufacturable optical laminate film and display device without rainbow-like unevenness.

An optical laminate film according to an aspect of the present invention includes: a support; an easily-adhesive layer provided on one surface of the support; and a transparent layer made of translucent resin provided on another surface of the support, wherein the transparent layer contains translucent particles, a volume average particle diameter r of the translucent particles satisfies 0.4 μm≦r≦3.0 μm, a total sum S of the translucent particles satisfies 30 mg/m²≦S≦500 mg/m², and an average film thickness t of the transparent layer satisfies r/4≦t<r.

The inventors have found that when the volume average particle diameter r of the translucent particles satisfies 0.4 μm≦r≦3.0 μm, the total sum S of the translucent particles satisfies 30 mg/m²≦S≦500 mg/m², and the average film thickness t of the transparent layer satisfies r/4≦t<r, rainbow-like unevenness can be prevented, thereby leading to the present invention.

An optical laminate film according to another aspect of the present invention includes: a support; an easily-adhesive layer provided on one surface of the support; and a transparent layer made of translucent resin provided on another surface of the support, wherein the transparent layer contains translucent particles, a volume average particle diameter r of the translucent particles satisfies 0.4 μm≦r≦3.0 μm, a total sum S of the translucent particles satisfies 30 mg/m²≦S≦500 mg/m², and a 10-point average roughness Rz of the transparent layer satisfies 0.5 μm≦Rz≦1.0 μm.

The inventors have found that when the volume average particle diameter r of the translucent particles satisfies 0.4 μm≦r≦3.0 μm, the total sum S of the translucent particles satisfies 30 mg/m²≦S≦500 mg/m², and the 10-point average roughness Rz of the transparent layer satisfies 0.5 μm≦Rz≦1.0 μm, rainbow-like unevenness can be prevented, thereby leading to the present invention.

In the optical laminate film according to still another aspect of the present invention, a haze value of the optical laminate film is preferably equal to or larger than 20% and equal to or smaller than 60%.

If the haze value is smaller than 20%, it is difficult to mitigate rainbow-like unevenness. If the haze value is larger than 60%, there is a high possibility of decreasing luminance when the film is assembled to a backlight.

In the optical laminate film according to still another aspect of the present invention, the transparent layer is formed of two layers including, from a side close to the support, a first transparent layer and a second transparent layer. The second transparent layer can be caused to function as a particle holding layer, the first transparent layer can be caused to function as an easily-adhesive layer for the second transparent layer and the support. By configuring the transparent layer with two layers, the ability of holding particles required for the transparent layer and adhesiveness to the support can be achieved. Also, to improve easy adhesiveness of the first transparent layer which is in contact with the support, the first transparent layer may be divided into two layers, or may hold part of particles.

In the optical laminate film according to still another aspect of the present invention, preferably, the transparent layer includes either one of metal oxide particles exhibiting conductivity by electron conduction and a π electron-conjugated conductive polymer, and the transparent layer has a surface resistance equal to or lower than 10¹² Ω/sq.

In the optical laminate film according to still another aspect of the present invention, preferably, the easily-adhesive layer includes either one of metal oxide particles exhibiting conductivity by electron conduction and a π electron-conjugated conductive polymer, and the easily-adhesive layer has a surface resistance equal to or lower than 10¹² Ω/sq.

The optical laminate film according to still another aspect of the present invention, preferably, may further include a lens layer provided on the easily-adhesive layer.

A display device according to an aspect of the present invention includes any one of the optical laminate films described above, which is mounted thereon.

The optical laminate sheet according to the present invention can be stably manufactured without rainbow-like unevenness.

### BRIEF DESCRIPTION OF THE DRAWINGS

FIG. 1 is a sectional view of an optical laminate film according to a first structure;

FIG. 2 is a sectional view of an optical laminate film according to a second structure; and

FIG. 3 is an exploded view of the structure of a display device.

### DETAILED DESCRIPTION OF THE PREFERRED EMBODIMENTS

Preferred embodiments of the present invention are described below according to the attached drawings. While the present invention is described based on the preferred embodiments below, modifications can be made with various techniques without deviating from the scope of the present invention, and embodiments other than the present embodiments can also be used. Therefore, all modifications within the scope of the present invention are included in the claims.

### First Embodiment

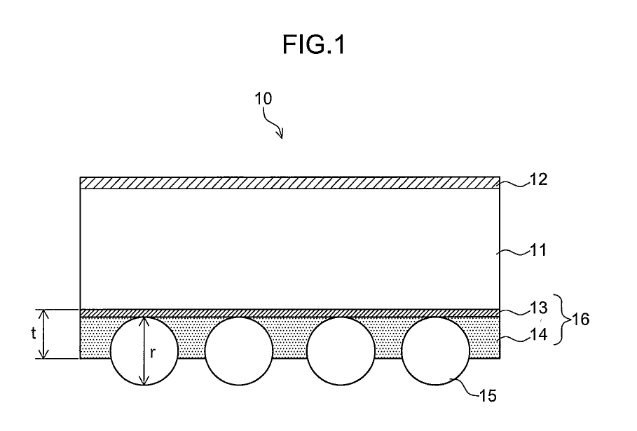

FIG. 1 is a sectional view of an optical laminate film according to a first structure of a first embodiment of the present invention. The optical laminate film 10 includes a support 11, an easily-adhesive layer 12 provided on one surface of the support 11, a first transparent layer 13 provided on the other surface of the support 11, a second transparent layer 14 provided adjacently to the first transparent layer 13, and translucent particles 15 arranged in the second transparent layer 14.

As a result of diligent studies by the inventors, it has been found that for prevention of rainbow-like unevenness, a volume average particle diameter r of translucent particles and an addition amount of translucent particles fall within predetermined ranges, and the volume average particle diameter r of the translucent particles and an average film thickness t of a transparent layer satisfies a predetermined relation, thereby solving these problems.

The volume average particle diameter r of the translucent particles 15 satisfies 0.4 μm≦r≦3.0 μm. The translucent particles 15 may have different particle diameters as long as the volume average particle diameter r of the translucent particles 15 satisfies the range mentioned above. Furthermore, particles having different particle diameters may be made of different types of materials. The volume average particle diameter r of the translucent particles 15 is preferably 0.7 μm≦r≦3.0 μm, and further preferably 1.0 μm≦r≦3.0 μm. A total sum S of the translucent particles 15 satisfies 30 mg/m²≦S≦500 mg/m². The sum is preferably 30 mg/m²≦S≦400 mg/m², further preferably 30 mg/m²≦S≦300 mg/m², and most preferably 70 mg/m²≦S≦300 mg/m². The total sum S of the translucent particles 15 can be found by shooting the particles by an optical microscope, measuring a particle diameter of each particle and counting the number of particles within a range of a unit area (a range that can be measured without unevenness, such as 1 cm²), converting a relative density for each type of particles to weight to find a total sum, and then converting the result to weight per 1 m². Also, the particle diameter can be measured by observing the surface and the section together with SEM.

The average film thickness t of the transparent layer 16 satisfies r/4≦t<r in relation to the volume average particle diameter r of the translucent particles 15. The thickness r is preferably r/3≦t<r, and further preferably r/2≦t<r. Since the volume average particle diameter r of the translucent particles 15 is larger than the average film thickness r of the transparent layer 16, the translucent particles 15 project from the surface of the transparent layer 16. However, this does not mean that all of the translucent particles 15 project. Also, projection does not necessarily require that the surface of the particle is exposed, but means that the height (film thickness) of the particle part is larger than the average film thickness. The average film thickness t of the transparent layer 16 can be found by shooting a photograph of the film by SEM with the number of counts allowing measurement without unevenness in film thickness, measuring the thickness at each part, and averaging these measurement values. At least 1550 projections/mm² or more, preferably 3350 projections/mm² or more are preferably configured of the translucent particles 15.

Regarding optical scatterability, a haze value of the optical laminate film 10 measured by a haze meter (NDH-2000, Nippon Denshoku Industries Co., Ltd.) by complying with JIS-K-7105 (JIS: Japanese Industrial Standards) is preferably within a range equal to or larger than 20% and equal to or smaller than 60%. The reason for this is as follows. With the haze value being set equal to or larger than 20%, mitigation of rainbow-like unevenness can be achieved. With the haze value being set equal to or smaller than 60%, a decrease in luminance when the film is assembled with a backlight can be prevented.

Also, the transparent layer 16 preferably has a 10-point average roughness Rz of 0.5 μm≦Rz≦1.0 μm.

With Rz being set equal to or larger than 0.5 μm, an appropriate front luminance and mitigation of rainbow-like unevenness can be achieved. With Rz being set equal to or smaller than 1.0 μm, excellent retainability of particles can be achieved.

The easily-adhesive layer 12 is provided on one surface of the support 11 in order to improve bondability of the support 11 with respect to an optical functional layer and increase adhesiveness with the optical functional layer.

While the transparent layer 16 arranged on the other surface of the support 11 has a two-layer structure including the first transparent layer 13 and the second transparent layer 14, in the first structure, the transparent layer 16 may have a one-layer structure.

The first transparent layer 13 serves as an easily-adhesive layer between the second transparent layer 14 and the support 11 in the first structure. The second transparent layer 14 functions as a retaining layer retaining the translucent particles 15. With the transparent layer 16 being configured of two layers, retainability of particles and bondability with the support 11 required for the transparent layer 16 can both be achieved.

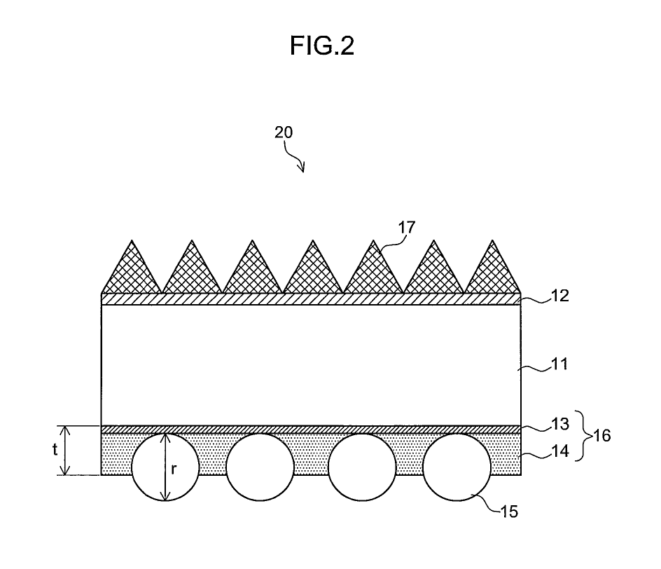

FIG. 2 is a sectional view of an optical laminate film according to a second structure of the first embodiment. An optical laminate film 20 includes a support 11, an easily-adhesive layer 12 provided on one surface of the support 11, a prism layer 17 provided as a lens layer on the easily-adhesive layer 12, a first transparent layer 13 provided on the other surface of the support 11, a second transparent layer 14 provided adjacently to the first transparent layer 13, and translucent particles 15 arranged in the second transparent layer 14.

The optical laminate film 20 is provided with a prism layer 17 as a lens layer on the easily-adhesive layer 12 of the optical laminate film 10 of the first structure.

The volume average particle diameter r of the translucent particles 15 satisfies 0.4 μm≦r≦3.0 μm, the total sum S of the translucent particles 15 satisfies 30 mg/m²≦S≦500 mg/m², and the average film thickness t of the transparent layer 16 satisfies r/4≦t<r in relation to the volume average diameter r of the translucent particles 15.

The prism layer 17 refracts incident light for gathering or diffusion. The prism layer 17 of FIG. 2 has a form in which a plurality of prisms each having a triangular section are arranged with predetermined pitches. When light enters from a transparent layer 16 side, the optical laminate film 20 having the above-structured prism layer 17 refract the incident light beam by the prisms toward a predetermined direction. As a result, light is emitted with a light distribution with a peak in the predetermined direction.

For example, when the incident light beam is refracted toward a direction of a normal line to a surface of the prism, the light distribution has a large peak in the direction of the normal line. When the optical laminate film 20 is used for a backlight unit of a liquid-crystal display, front luminance of the liquid-crystal display can be improved. However, when the transparent layer 16 containing the translucent particles 15 is not arranged on the prism layer 17, if the prism layer 17 is arranged on a backlight and the backlight is lit up and viewed from a diagonal direction, rainbow-like unevenness disadvantageously appears, that is, a portion supposed to be viewed as white is viewed as being color-shifted from white. In the present embodiment, because the volume average particle diameter r of the translucent particles 15 and the addition amount of the translucent particles 15 respectively fall within predetermined ranges, and because the volume average particle diameter r of the translucent particles 15 and the average film thickness t of the transparent layer 16 satisfy a predetermined relation, occurrence of rainbow-like unevenness can be prevented.

In the second structure, the prism layer 17 has a shape in which a plurality of prisms each having a triangular section are arranged with predetermined pitches. However, this is not meant to be restrictive. For example, the prism apical angle may be curved, or the prism itself may not be linear but have some undulation.

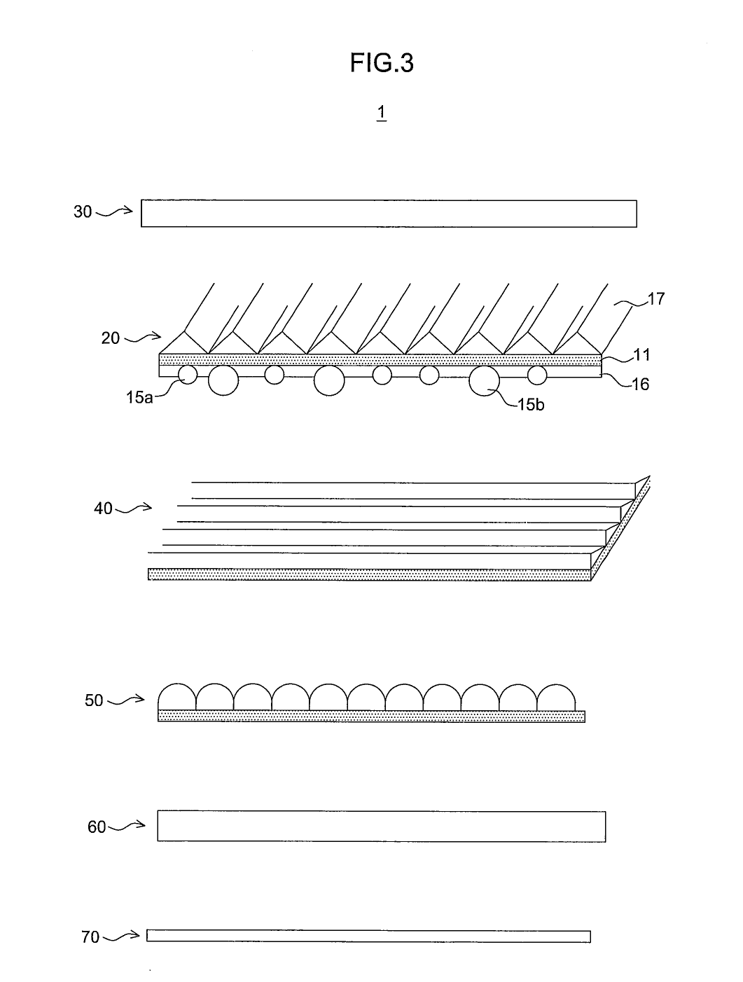

FIG. 3 is a schematic diagram showing the structure of an example of a display device using the optical laminate film 20 according to the second structure, and this is not particularly meant to be restrictive.

A display device 1 includes the optical laminate film 20, a liquid-crystal panel unit 30 arranged on the prism layer 17 side of the optical laminate film 20, a prism sheet 40 arranged on a transparent layer 16 side of the optical laminate film 20, a microlens sheet 50 arranged on a side of the prism sheet 40 opposite to the optical laminate film 20 side, a light-guiding plate 60 arranged on a side of the microlens sheet 50 opposite to a prism sheet 40 side, and a reflective sheet 70 arranged on a side of the light-guiding plate 60 opposite to a microlens sheet 50. Also, the device is used with lamp light incident from a side surface of the light-guiding plate 60. The display device 1 does not have a diffusion sheet between the liquid-crystal panel unit 30 and the optical laminate film 20.

The liquid-crystal panel unit 30 has a form with both surfaces of a liquid panel interposed between two optical polarizing plates. In the display device 1, a diffusion sheet can be used in place of the microlens sheet 50. Also, a direct backlight can be used in place of the light-guiding plate 60.

Various combinations of the prism sheet 40, the microlens sheet 50, the light-guiding plate 60, and the reflective sheet 70 arranged on the transparent layer 16 side of the optical laminate film 20 can be thought according to the specifications desired for the display device 1.

### Second Embodiment

A second embodiment includes a first structure and a second structure substantially similar to those of the first embodiment. Structures similar to those in the optical laminate films 10 and 20 shown in FIG. 1 and FIG. 2 are provided with the same reference numerals and are not described herein in some cases.

As a result of diligent studies by the inventors, it has been found that for prevention of rainbow-like unevenness, the volume average particle diameter r of the translucent particles, the addition amount of translucent particles, and a 10-point average roughness Rz of a transparent layer satisfy a predetermined relation, thereby solving the problems described above.

The volume average particle diameter r of the translucent particles 15 satisfies 0.4 μm≦r≦3.0 μm. The translucent particles 15 may have different particle diameters as long as the volume average particle diameter r of the translucent particles 15 satisfies the range mentioned above. Furthermore, particles having different particle diameters may be made of different types of materials. The volume average particle diameter r of the translucent particles 15 is preferably 0.7 μm≦r≦3.0 μm, and further preferably 1.0 μm≦r≦3.0 μm. A total sum S of the translucent particles 15 satisfies 30 mg/m²≦S≦500 mg/m². The sum is preferably 30 mg/m²≦S≦400 mg/m², further preferably 30 mg/m²≦S≦300 mg/m², and most preferably 70 mg/m²≦S≦300 mg/m². The total sum S of the translucent particles 15 can be found by shooting the particles by an optical microscope, measuring a particle diameter of each particle and counting the number of particles within a range of a unit area (a range that can be measured without unevenness, such as 1 cm²), converting a relative density for each type of particles to weight to find a total sum, and then converting the result to weight per 1 m². Also, the particle diameter can be measured by observing the surface and the section together with SEM.

Also, the 10-point average roughness Rz of the transparent layer 16 is preferably in a range of 0.5μm≦Rz≦1.0 μm. If Rz is smaller than 0.5 μm, it is difficult to mitigate rainbow-like unevenness while achieving front luminance. If Rz is larger equal to or larger than 1.0 μm, the ability of holding particles may deteriorate. When Rz and the average particle diameter are as described above, the translucent particles 15 project from the surface of the transparent layer 16. However, this does not mean that all of the translucent particles 15 project. Also, projection does not necessarily require that the surface of the particle is exposed, but means that the height (film thickness) of the particle part is larger than the average film thickness. At least 1550 projections/mm² or more, preferably 3350 projections/mm² or more are preferably configured of the translucent particles 15.

Regarding optical scatterability, a haze value of the optical laminate film 10 measured by a haze meter (NDH-2000, Nippon Denshoku Industries Co., Ltd.) by complying with JIS-K-7105 is preferably within a range equal to or larger than 20% and equal to or smaller than 60%.

The easily-adhesive layer 12 is provided on one surface of the support 11 in order to improve bondability of the support 11 with respect to an optical functional layer and increase adhesiveness with the optical functional layer.

While the transparent layer 16 arranged on the other surface of the support 11 has a two-layer structure, that is, the first transparent layer 13 and the second transparent layer 14, in the first structure, the transparent layer 16 may have a one-layer structure.

The first transparent layer 13 serves as an easily-adhesive layer between the second transparent layer 14 and the support 11 in the first structure. The second transparent layer 14 functions as a retaining layer retaining the translucent particles 15. With the transparent layer 16 being configured of two layers, retainability of particles and bondability with the support 11 required for the transparent layer 16 can both be achieved.

FIG. 2 is a sectional view of an optical laminate film according to a second structure of the second embodiment. An optical laminate film 20 includes a support 11, an easily-adhesive layer 12 provided on one surface of the support 11, a prism layer 17 provided as a lens layer on the easily-adhesive layer 12, a first transparent layer 13 provided on the other surface of the support 11, a second transparent layer 14 provided adjacently to the first transparent layer 13, and translucent particles 15 arranged in the second transparent layer 14.

The optical laminate film 20 is provided with a prism layer 17 as a lens layer on the easily-adhesive layer 12 of the optical laminate film 10 of the first embodiment.

The prism layer 17 refracts incident light for gathering or diffusion. The prism layer 17 of FIG. 2 has a form in which a plurality of prisms each having a triangular section are arranged with predetermined pitches. When light enters from a transparent layer 16 side, the optical laminate film 20 having the above-structured prism layer 17 refract the incident light beam by the prisms toward a predetermined direction. As a result, light is emitted with a light distribution with a peak in the predetermined direction. For example, when the incident light beam is refracted toward a direction of a normal line, the light distribution has a large peak in the direction of the normal line. When the optical laminate film 20 is used for a backlight unit of a liquid-crystal display, front luminance of the liquid-crystal display can be improved.

However, when the transparent layer 16 containing the translucent particles 15 is not arranged on the prism layer 17, if the prism layer 17 is arranged on a backlight and the backlight is lit up and viewed from a diagonal direction, rainbow-like unevenness disadvantageously appears, that is, a portion supposed to be viewed as white is viewed as being color-shifted from white. In the present embodiment, the volume average particle diameter r of the translucent particles 15, the addition amount of the translucent particles 15 and the 10-point average roughness Rz of the transparent layer 16 respectively fall within predetermined ranges, thereby preventing occurrence of rainbow-like unevenness.

In the second structure, the prism layer 17 has a shape in which a plurality of prisms each having a triangular section are arranged with predetermined pitches. However, this is not meant to be restrictive. For example, the prism apical angle may be curved, or the prism itself may not be linear but have some undulation.

FIG. 3 is a schematic diagram showing the structure of an example of a display device using the optical laminate film 20 according to the second structure of the second embodiment, and this is not particularly meant to be restrictive.

A display device 1 includes the optical laminate film 20, a liquid-crystal panel unit 30 arranged on the prism layer 17 side of the optical laminate film 20, a prism sheet 40 arranged on a transparent layer 16 side of the optical laminate film 20, a microlens sheet 50 arranged on a side of the prism sheet 40 opposite to the optical laminate film 20 side, a light-guiding plate 60 arranged on a side of the microlens sheet 50 opposite to a prism sheet 40 side, and a reflective sheet 70 arranged on a side of the light-guiding plate 60 opposite to a microlens sheet 50. Also, the device is used with lamp light incident from a side surface of the light-guiding plate 60. The display device 1 does not have a diffusion sheet between the liquid-crystal panel unit 30 and the optical laminate film 20.

The liquid-crystal panel unit 30 has a form with both surfaces of a liquid panel interposed between two optical polarizing plates. In the display device 1, a diffusion sheet can be used in place of the microlens sheet 50. Also, a direct backlight can be used in place of the light-guiding plate 60.

Various combinations of the prism sheet 40, the microlens sheet 50, the light-guiding plate 60, and the reflective sheet 70 arranged on the transparent layer 16 side of the optical laminate film 20 can be thought according to the specifications desired for the display device 1.

Next, materials and others for use in the optical laminate film of the present embodiment are described.

[Support]

The support 11 is made by forming a high polymer compound in a film shape by using a melting film-forming method or a solution film-forming method. The high polymer compound for use in the support 11 is transparent.

Preferable examples of the support 11 include polyethylene terephthalate (PET), polyethylene naphthalate (PEN), polybutylene terephthalate (PBT), polybutylene naphthalate (PBN), polyallylates, polyethersulphone, polycarbonate, polyetherketone, polysulphone, polyphenylenesulfide, polyester-based liquid-crystal polymer, triacetylcellulose, cellulose derivatives, polypropylene, polyamides, polyimide, and polycycloolefins.

Among these, PET, PEN, triacetylcellulose, and cellulose derivatives are more preferable, and PET and PEN are particularly preferable.

As the support 11, what is preferable is a so-called biaxial-orientation high polymer film with the high polymer compound described above formed in a long film shape being stretched in two directions, a longitudinal direction and a width direction, orthogonal to each other, and a biaxially-stretched film-shaped PET and PEN is particularly preferable in view of a modulus of elasticity and transparency.

Also, at least one of the one and the other surfaces of the support 11 may be subjected to a corona discharge process. With a corona discharge process, one or both of the one and the other surfaces are subjected to hydrophilization, and wettability of various water-based coating fluids can be improved. Furthermore, a functional group such as a carboxyl group or a hydroxyl group can be introduced. With this, adhesiveness between the one surface of the support 11 and the other surface of the easily-adhesive layer 12 or between the other surface of the support 11 and the transparent layer 16 can be more increased.

The support 11 has a thickness of 100 μM to 350 μm. Within this range, an optical laminate film having an optimum thickness can be obtained as a backlight unit component.

The support 11 preferably has a refractive index of 1.40 to 1.80, although the value varies depending on the material for use. Within this range, an optical laminate film having excellent stiffness as a base material and also excellent in transparency can be obtained.

[Transparent Layer]

The transparent layer 16 is arranged on a side opposite to the side where the easily-adhesive layer 12 of the support 11 is present. The transparent layer 16 may include one layer, but is preferably configured of two layers, that is, the first transparent layer 13 and the second transparent layer 14.

In a relation with a volume average particle diameter r of all of the translucent particles 15, the transparent layer 16 preferably has an average film thickness t satisfying r/4≦t<r, more preferably r/3≦t<r, and further preferably r/2≦t<r. If the average thickness t is smaller than r/4, bondability for retaining the translucent particles 15 may be insufficient. Also, if the average thickness t is larger than r, it is disadvantageously difficult to mitigate rainbow-like unevenness and achieve front luminance both.

In the present embodiment, with coating of a low-viscosity fluid by a wire bar, it is possible to perform precise coating achieving the film thickness described above even with small-sized particles.

(First Transparent Layer)

The first transparent layer 13 is normally formed by applying a coating fluid made of a binder, a curing agent, and a surface active agent onto the other surface of the support 11. As the material for use as the first transparent layer 13, a suitable material is preferably selected for the purpose of fixing the translucent particles 15 onto the support 11. Also, no curing agent may be used, and the binder itself may have self-crosslinking properties.

The binder used for the first transparent layer 13 is not particularly restrictive. However, in view of adhesiveness to the support 11, at least one of polyester, polyurethane, acrylic resin, and styrene-butadiene copolymer is preferable. Also, a water-soluble or water-dispersive binder is particularly preferable in view of less load on the environment.

The first transparent layer 13 may include metal oxide particles exhibiting conductivity by electron conduction. As the metal oxide particles, general metal oxides can be used, and examples include ZnO, TiO₂, SnO₂, Al₂O₃, In₂O₃, MgO, BaO, MoO₃, and composite oxides thereof, and these metal oxides may contain a small amount of any different element. Among these metal oxides, SnO₂, ZnO, TiO₂, and In₂O₃ are preferable, and SnO₂ is particularly preferable. In place of the metal oxide particles exhibiting conductivity by electron conduction, a π electron-conjugated conductive polymer may be contained, such as a polythiophene-based polymer.

By adding metal oxide particles exhibiting conductivity by electron conduction or a π electron-conjugated conductive polymer to the first transparent layer 13, the surface resistance of the first transparent layer 13 is adjusted to be equal to or lower than 10¹² Ω/sq (Ω per square). With this, sufficient antistatic prevention can be achieved, thereby preventing absorption of dust and dirt onto the optical laminate films 10 and 20.

Fine particles made of metal oxide may be contained in the first transparent layer 13 in order to adjust the refractive index of the first transparent layer 13. A s the metal oxide, metal oxide with a high refractive index is preferable, such as tin oxide, zirconium oxide, zinc oxide, titanium oxide, cerium oxide, or niobium oxide because metal oxide with a high refractive index can change the refractive index even with a small amount. The particle diameter of the fine particles made of metal oxide is preferably in a range of 1 nm to 50 nm, and particularly preferably in a range of 2 nm to 40 nm. Although the amount of the fine particles of metal oxide can be determined according to a target refractive index, the fine particles are preferably contained in the first transparent layer 13 so that the mass of the fine particles is in a range of 10 to 90 when the total mass of the translucent resin is assumed to be 100, and particularly preferably in a range of 30 to 80. The first transparent layer 13 preferably has a refractive index in a range of 1.4 to 1.8.

The first transparent layer 13 preferably has a thickness of 0.05 μm to 0.3 μm. If the thickness exceeds 0.3 μm, interference unevenness due to a subtle change of the film thickness of the second transparent layer 14 may occur. If the thickness is below 0.05 μm, it is difficult to exhibit easy adhesiveness. Also, the first transparent layer 13 may partially retain the translucent particles 15.

[Second Transparent Layer]

The second transparent layer 14 is provided so as to be in contact with the frst transparent layer 13. The second transparent layer 14 is preferably a hard coat layer having high hardness and anti-damage properties. With this, the optical laminate films 10 and 20 can be prevented from being damaged.

The second transparent layer 14 retains translucent particles 15. The second transparent layer 14 preferably has a thickness of 0.4 μm to 3.0 μm. The thickness of the second transparent layer 14 is determined in consideration of the volume average particle diameter r of the entire translucent particles 15.

The thickness of the second transparent layer 14 can be controlled by adjusting the amount of coating of the coating fluid for the second transparent layer.

When a foreign substance is attached onto the surfaces of the optical laminate films 10 and 20, the foreign substance interferes with transmission of UV light as radiation light at the time of curing for forming the prism layer 17. With the interference with transmission of UV light, the prism layer 17 is not partially cured to cause a defect. In this case, yields of the optical laminate films 10 and 20 are decreased. Moreover, the time required for curing in order to obtain a uniform prism layer 17 of the optical laminate film 20 is increased. Thus, the surface resistivity of the second transparent layer 14 at 25° C. with 40% RH is preferably equal to or larger than 10⁸ Ω/sq and equal to or smaller than 10¹² Ω/sq. With this, the antistatic preventive function is provided to the optical laminate films 10 and 20.

As a method of forming the second transparent layer 14 with the above-described surface resistivity in order to provide an antistatic function to the optical laminate films 10 and 20, an ionic antistatic agent, such as cation, anion, or betaine, is preferably added to the coating fluid for the second transparent layer. Among these, a betaine-based compound having a imidazolinium skeleton, such as 2-alkyl-N-carboxyethyl-N-hydroxyethyl imidazolinium betaine, is preferable. In place of or in addition to an ionic antistatic agent, fine particles made of metal oxide, such as conductive tin oxide, indium oxide, zinc oxide, titanium oxide, magnesium oxide, or antimony oxide, may be used.

Note that the haze value can be adjusted to 20% to 60% by adjusting the total sum S of the translucent particles 15 in the second transparent layer 14.

The coating fluid for the second transparent layer for forming the second transparent layer 14, a photo-curable resin containing a photopolymerization initiator may be used, but a thermosetting coating fluid without requiring a photopolymerization initiator is preferable. That is, the second transparent layer 14 is formed by applying a thermosetting coating fluid and curing this coating fluid for the second transparent layer by heating.

As a photo-curable resin, a translucent polymer having a saturated hydrocarbon chain, or a polyether chain as a main chain is used. Also, a main binder polymer after curing preferably has a crosslink structure. As a binder polymer having a saturated hydrocarbon chain as a main chain after curing, a polymer obtained from an ethyleny unsaturated monomer selected from a first group of compounds described below. As a polymer having a polyether chain as a main chain, a polymer obtained by ring-opening an epoxy-based monomer selected from a second group of compounds described below. Furthermore, a polymer of a mixture of these monomers can be thought. As a binder polymer of the compounds in the first group having a saturated hydrocarbon chain as a main chain and having a crosslink structure, a (co)polymer of a monomer having two or more ethyleny unsaturated groups is preferable. To increase the refractive index of the obtained polymer, an aromatic ring or at least one type selected from a halogen atom other than fluorine, a sulfur atom, a phosphorus atom, and a nitrogen atom is preferably contained in the structure of the monomer. Also, examples of a monomer having two or more ethyleny unsaturated groups for use in the resin layer include ester from polyalcohol and (metha)acrylic acid {for example, ethyleneglycoldi(metha)acrylate, 1,4-cyclohexanediacrylate, pentaerythritoltetra(metha)acrylate, pentaerythritoltri(metha)acrylate, trimethylolpropanetri(metha)acylate, trimethylolethanetri(metha)acrylate, dipentaerythritoltetra(metha)acrylate, dipentaerythritolpenta(metha)acrylate, dipentaerythritolhexa(metha)acrylate, pentaerythritolhexa(metha)acrylate, 1,2,3-cyclohexanetetramethacrylate, polyurethanepolyacrylate, and polyesterpolyacrylate}, vinylbenzene and its derivatives (for example, 1,4-divinylbenzene, 4-divinylbenzoicacid-2-acryloylethylester, and 1,4-divinylcyclohexanone), vinylsulfone (for example, divynylsulfone), (metha)acrylamide (for example, methylenebisacrylamide) and others.

As a material to be cured by heat, general thermosetting resin can be used, such as a urethane resin, epoxy resin, phenol resin, melamine resin, urea resin, amino resin, or silicone-based material. In particular, since a silicone resin having a three-dimensionally-crosslinked siloxane bond has a high crosslink density, a high-hardness film can be formed.

Among these, as a material for use as the second transparent layer 14, a water-soluble or water-dispersive material is preferably used, and the use of a water-based coating fluid for the second transparent layer made of any of these materials is particularly preferable in view of reducing environmental contamination due to VOC (volatile organic compounds).

A suitably-usable coating fluid for the second transparent layer forming the second transparent layer 14 is a so-called silica-based compound, containing an aqueous solution of silanol yielded by hydrolyzing tetraalkoxysilane and an organosilicon compound represented by General Formula (1) below in an acidic aqueous solution, a water-soluble curing agent for dehydration and condensation of the silanol, and colloidal silica in which colloid particles dispersed in water have an average particle diameter equal to or larger than 3 nm and equal to or smaller than 50 nm.

R¹Si(OR²)₃ (1)

(Here, R¹ is an organic group with a carbon number equal to or larger than 1 and equal to or smaller than 15 without containing an amino base, and R² is a methyl or ethyl group)

<Organosilicon Compound of General Formula (1)>

As a preferable compound of the organosilicon compound in General Formula (1) as a first component of the coating fluid for the second transparent layer, the following can be used: vinyltrimethoxysilane, 3-methacryloxypropyltrimethoxysilane, 3-acryloxypropyltrimethoxysilane, 3-chloropropyltrimethoxysilane, 3-ureidepropyltrimethoxysilane, propyltrimethoxysilane, phenyltrimethoxysilane, 3-glycidexypropyltriethoxysilane, 2-(3,4-epoxycyclohexyl)ethyltriethoxysilane, vinyltriethoxysilane, 3-methacryloxypropyltriethoxysilane, 3-acryloxypropyltriethoxysilane, 3-chloropropyltriethoxysilane, 3-ureidepropyltriethoxysilane, propyltriethoxysilane, phenyltriethoxysilane, 3-glycidexypropylmethyldimethoxysilane, 2-(3,4-epoxycyclohexyl)ethylmethyldimethoxysilane, vinylmethyldimethoxysilane, 3-methacryloxypropylmethyldimethoxysilane, 3-acryloxypropylmethyldimethoxysilane, chloropropylmethyldimethoxysilane, propylmethyldimethoxysilane, phenylmethyldimethoxysilane, 3-glycidexypropylmethyldiethoxysilane, 2-(3,4-epoxycyclohexyl)ethylmethyldiethoxysilane, vinylmethyldiethoxysilane, 3-methacryloxypropylmethyldiethoxysilane, 3-acryloxypropylmethyldiethoxysilane, chloropropylmethyldiethoxysilane, propylmethyldiethoxysilane, phenylmethyldiethoxysilane, 3-trimethoxysilylpropyl-2-[2-(methoxyethoxy)ethoxy]ethylurethane, 3-triethoxysilylpropyl-2-[2-(methoxyethoxy)ethoxy]ethylurethane, 3-trimethoxysilylpropyl-2-[2-(methoxypropoxy)propoxy]propylurethane, and 3-triethoxysilylpropyl-2-[2-(methoxypropoxy)propoxy]propylurethane.

Among these, trialkoxysilane with n=0 is more preferable, such as 3-glycidexypropyltrimethoxysilane, 3-chloropropyltrimethoxysilane, 2-(3,4-epoxycyclohexyl)ethyltrimethoxysilane, 3-ureidepropyltriethoxysilane, 3-trimethoxysilylpropyl-2-[2-(methoxyethoxy)ethoxy]ethylurethane, and 3-trimethoxysilylpropyl-2-[2-(methoxypropoxy)propoxy]propylurethane.

The organosilicon compound represented by General Formula (1) does not contain an amino group as a functional group. That is, this organosilicon compound has an organic group R¹ without an amino group. If R¹ has an amino group, when it is mixed with tetraalkoxysilane for hydrolyzation, dehydration and condensation are promoted between silanols, thereby causing the coating fluid for the second transparent layer unstable. R¹ can be an organic group having a molecular chain length with a carbon number equal to or larger than 1 and equal to or smaller than 15. However, in order to obtain the second transparent layer 14 with brittleness being more mitigated and to further improve adhesiveness between the second transparent layer 14 and the first transparent layer 13, the range of the carbon number is more preferably equal to or larger than 3 and equal to or smaller than 15 and, further preferably equal to or larger than 5 and equal to or smaller than 13. Note that with the carbon number being set equal to or smaller than 15, flexibility of the second transparent layer 14 is not so large and a sufficient hardness can be achieved, compared with the case in which the carbon number is set equal to or smaller than 16.

Then, the organic group indicated by R¹ preferably has a heteroatom, such as oxygen, nitrogen, or sulfur. With the organic group having a heteroatom, adhesiveness with the first transparent layer 13 can be further improved. In particular, an epoxy group, an amid group, an urethane group, an urea group, an ester group, a hydroxy group, or carboxyl group is preferably present in the organic group R¹. Among these, an organosilicon compound containing an epoxy group is particularly preferable because it has an effect of increasing stability of silanol in acid water.

<Tetraalkoxysilane>

By using tetraalkoxysilane as the coating fluid for the second transparent layer, the crosslink density by dehydration and condensation of silanol yielded by hydrolyzation of tetraalkoxysilane and an organosilicon compound in General Formula (1) is increased. With this, a layer harder than ever can be formed.

Tetraalkoxysilane is not particularly restrictive, but is preferably the one having a carbon number of 1 to 4, and tetramemethoxysilane and tetraethoxysilane are particularly preferable. With the carbon number being equal to or lower than 4, compared with the case in which the carbon number is equal to or higher than 5, the hydrolysis speed of tetraalkoxysilane when mixed with acid water is not too slow, and the time required for dissolution to a uniform aqueous solution becomes shorter.

When it is assumed in the general formula that the mass of the organosilicon is X1 and the mass of tetraalkoxysilane is X2, tetraalkoxysilane preferably has a mass ratio, which is found with {X2/(X1+X2)}×100, in a range equal to or larger than 20% and equal to or smaller than 95% and, more preferably, in a range equal to or larger than 30% and equal to or smaller than 90%. With the mass ratio being set in this range, crosslink density can be increased, and therefore the second transparent layer 14 having a sufficiently high hardness with brittleness being more mitigated can be obtained. When the mass ratio is smaller than 20%, crosslink density is not too low compared with the case of smaller than 20%, and therefore the second transparent layer 14 becomes sufficiently hardness. Also, when the mass ratio is equal to or smaller than 90%, crosslink density is not too high compared with the case of exceeding 90%. For this reason, the second transparent layer 14 with excellent flexibility and without brittleness can be more reliably obtained.

[Acid Water]

Acid water as a third component of the coating liquid preferably has a hydrogen ion exponent (pH) equal to or larger than 2 and equal to or higher than 6, more preferably equal to or larger than 2.5 and equal to or higher than 5.5. If pH is smaller than 2 or larger than 6, when tetraalkoxysilane and an organosilicon compound represented by General Formula (1) are mixed in this acid water to obtain an aqueous solution, after alkoxysilan is hydrolyzed in this aqueous solution, that is, an alkoxysilan aqueous solution, to yield silanol, silanol proceed to be condensed, and the viscosity of this aqueous solution tends to increase. Note that the pH value described above is a value at 25° C., which is a so-called “ambient temperature”.

The acid water is obtained by dissolving organic acid or inorganic acid in water. Acid is not particularly restrictive, but organic acids such as acetic acid, propionic acid, formic acid, fumaric acid, maleic acid, oxalic acid, malonic acid, succinic acid, citric acid, malic acid, and ascorbic acid and inorganic acids such as hydrochloric acid, nitric acid, sufuric acid, phosphoric acid, and boric acid can be used. Among these, acetic acid is preferable in view of ease of handling.

The alkoxysilane is prepared so that the amount of acid water is in a range equal to or larger than 60 parts by mass and equal to or smaller than 2000 parts by mass when a total amount of tetraalkoxysilane and the organosilicon compound represented by General Formula (1), that is, the amount of alkoxysilan used, is taken as 100 parts by mass. With this composition, a hydrolytic aqueous solution of alkoxysilane with excellent hydrolyzability and stability of yielded silanol can be obtained. The coating fluid for the second transparent layer obtained by using this hydrolytic aqueous solution of alkoxysilane, that is, a silanol aqueous solution, is excellent in stability even it is water-based. Thus, the storage time until the start of producing the optical laminate films 10 and 20 is less restrictive, and there is no need to change the producing conditions at continuous production of the optical laminate films 10 and 20 according to changes in properties of the coating fluid for hard coat. The amount of acid water is more preferably in a range equal to or larger than 100 parts by mass and equal to or smaller than 1500 parts by mass with respect to the total amount of tetraalkoxysilane and the organosilicon compound represented by General Formula (1) of 100 parts by mass, particularly preferably in a range equal to or larger than 150 parts by mass and equal to or smaller than 1200 parts by mass. If acid water is smaller than 60 parts by mass with respect to the 100 parts by mass alkoxysilane, silanol yielded by hydrolyzing alkoxysilane is dehydrated and condensed to make the aqueous solution prone to be gelated. With 60 parts or more by mass, this gelation can be reliably suppressed. On the other hand, if acid water is equal to or smaller than 2000 parts by mass, the concentration of alkoxysilane in the coating fluid is high, and therefore the amount of coating for forming a sufficient thickness of the second transparent layer 14 does not become too much, compared with the case of exceeding 2000 parts by mass. Therefore, it is possible to reliably prevent unevenness in thickness of the coating fluid for the second transparent layer and a protracted time of drying the coating.

Note that a silane compound different from tetraalkoxysilane and the organosilicon compound represented by General Formula (1) can be used as the coating fluid for the second transparent layer. In this case, these components are preferably mixed so that acid water is in a range equal to or smaller than 60 parts by mass and equal to or smaller than 2000 parts by mass with respect to 100 parts by mass a total amount of tetraalkoxysilane and the organosilicon compound represented by General Formula (1) and the other silane compound.

<Colloidal Silica>

As a fourth component, colloidal silica may be contained in the coating fluid for the second transparent layer. This colloidal silica is a colloid in which silicon dioxide or its hydrate is dispersed in water, and colloid particles have an average particle diameter in a range of 3 nm to 50 nm. With the average particle diameter of the colloid particles being equal to or larger than 3 nm, viscosity of the coating fluid for the second transparent layer is not too high, and therefore addition of colloidal silica does not restrict the coating conditions, and the second transparent layer 14 can be formed harder. Also, with the average particle diameter of the colloid particles being equal to or smaller than 50 nm, scattering of incident light to the second transparent layer 14 is not too large, and therefore transparency of the optical laminate films 10 and 20 are not impaired. The average particle diameter of the colloid particles is preferably in a range of 4 nm to 50 nm, more preferably in a range of 4 nm to 40 nm, and particularly preferably in a range of 5 nm to 35 nm.

Note that pH of colloidal silica at the time of being added to the coating fluid for the second transparent layer is more preferably adjusted in a range equal to or larger than 2 and equal to or smaller than 7. If this pH is equal to or larger than 2 and equal to or smaller than 7, stability of silanol, which is a hydrolysate of alkoxysilane, is better, and an increase in viscosity of the coating fluid due to quick dehydration and condensation of silanol can be more reliably suppressed, compared with the case in which pH is smaller than 2 or larger than 7.

The amount of colloidal silica is preferably in a range equal to or larger than 40 parts by mass and equal to or smaller than 200 parts by mass, and, more preferably in a range equal to or larger than 80 parts by mass and equal to or smaller than 150 parts by mass, with respect to 100 parts by mass a total amount of tetraalkoxysilane and the organosilicon compound represented by General Formula (1). When the amount of colloidal silica is smaller than 40 parts by mass, a volume shrinkage ratio due to dehydration and condensation at the time of heating and curing is increased to possibly cause a crack in the cured film. With the amount being equal to or larger than 40 parts by mass, this crack can be more reliably suppressed. Also, when the amount of addition of colloidal silica exceeds 200 parts by mass, brittleness of the film is increased, and a crack may occur by bending the optical laminate films 10 and 20. This phenomenon can be more reliably prevented by setting the amount equal to or smaller than 200 parts by mass.

<Curing Agent>

A curing agent as a fifth component of the coating fluid is preferably soluble in water. The curing agent promotes dehydration and condensation of silanol to facilitate formation of a siloxane bond. As a water-soluble curing agent, a water-soluble inorganic acid, organic acid, salt of an organic acid, salt of an inorganic acid, metal alkoxide, or metal complex can be used.

Preferable examples of inorganic acid include boric acid, phosphoric acid, hydrochloric acid, nitric acid, and sulfuric acid.

Preferable examples of organic acid include acetic acid, formic acid, oxalic acid, citric acid, malic acid, and ascorbic acid.

Preferable examples of salt of organic acid include aluminum acetate, aluminum oxalate, zinc acetate, zinc oxalate, magnesium acetate, magnesium oxalate, zirconium acetate, and zirconium oxalate.

Preferable examples of salt of inorganic acid include aluminum chloride, aluminum sulfate, aluminum nitrate, zinc chloride, zinc sulfate, zinc nitrate, magnesium chloride, magnesium sulfate, magnesium nitrate, zirconium chloride, zirconium sulfate, and zirconium nitrate.

Preferable examples of the metal alkoxide include aluminum alkoxide, titanium alkoxide, and zirconium alkoxide.

Preferable examples of metal complex include aluminum acetylacetonate, aluminum ethylacetoacetate, titanium acetylacetonate, and titanium ethylacetoacetate.

Among the above-described curing agents, in particular, compounds containing boron, such as boric acid, phosphoric acid, aluminum alkoxide, and aluminum acetylacetonate, compounds containing phosphrous, and compounds containing aluminum are preferable in view of stability in water. Among these, at least any one type can be used as the curing agent.

The curing agent is preferably uniformly mixed and dissolved in the coating fluid, and dissolving the curing agent in water as a solvent for the coating fluid for the second transparent layer in the present invention is preferable in ensuring transparency of the second transparent layer 14. If solubility in water is low, the curing agent is present as a solid in the coating fluid, and therefore it remains as a foreign substance even after coating and drying and, in some cases, the second transparent layer 14 may have low transparency.

The amount of the curing agent is preferably in a range from 0.1 parts by mass or larger to 20 parts by mass or smaller with respect to 100 parts by mass of all alkoxysilane containing tetraalkoxysilane and the organosilicon compound represented by General Formula (1) and, more preferably in a range from 0.5 parts by mass or larger to 10 parts by mass or smaller, and a range from 1 part by mass or larger to 8 parts by mass or smaller is particularly preferable.

<Other Additives>

To control the surface characteristics, in particular, coefficients of friction, of the optical laminate films 10 and 20, the coating fluid for the second transparent layer may contain a wax.

As a wax, paraffin wax, microwax, polyethylene wax, polyester-based wax, carnauba wax, fatty acid, fatty amide, metallic soap, or others can be used.

Also, the coating fluid for the second transparent layer may contain a surface active agent. By using the surface active agent, surface tension of the coating fluid for the second transparent layer is decreased, coating unevenness of the coating fluid for the second transparent layer with respect to the first transparent layer 13 is suppressed, and the second transparent layer 14 having a uniform thickness can be formed on the first transparent layer 13. The surface active agent is not particularly restrictive, and any of aliphatic, aromatic, and fluorine-based surface active agents may be used, and any of nonion-based, anion-based, and cation-based surface active agents may be used.

[Translucent Particles]

In the present embodiment, a particle having a primary particle diameter equal to or larger than 100 nm is defined as a translucent particle. When the diameter is smaller than 100 nm, the particle is substantially transparent in a binder and does not achieve a diffusion function.

Examples of translucent particles 15 include organic resin fine particles and inorganic resin particles. Examples of these particles include silica, calcium carbonate, magnesium carbonate, barium sulfate, polystyrene, polystyrene-divinylbenzene copolymer, polymethylmethacrylate, crosslinked polymethylmethacrylate, styrene/acrylic copolymer, melamine, and benzoguanamine. Preferably, particles of at least one type selected from the following group are used: melamine resin particles, hollow particles, polystyrene resin particles, and styrene/acrylic copolymer resin particles, and silicone resin particles.

The volume average particle diameter r of the translucent particles 15 is preferably equal to or larger than 0.4 μm and equal to or smaller than 3.0 μM, more preferably equal to or larger than 0.7 μm and equal to or smaller than 3.0 μm, further preferably equal to or larger than 1.0 μm and equal to or smaller than 3.0 μm.

The volume average particle diameter r of the translucent particles 15 satisfies r/4≦t<r with respect to an average film thickness t of the transparent layer 16. The total sum S of the translucent particles 15 satisfies 30 mg/m²≦S≦500 mg/m². If the total sum S is smaller than 30 mg/m², it is disadvantageously difficult to mitigate rainbow-like unevenness. If the total sum S is larger than 500 mg/m², the amount of particles is too much, and powder removal disadvantageously occurs due to missing or falling of particles. Therefore, by setting the range as described above, stable production can be made while rainbow-like unevenness are suppressed.

Alternatively, the volume average particle diameter r of the translucent particles 15 satisfies 0.4 μm≦r≦3.0 μm, the total sum S of the translucent particles 15 satisfies 30 mg/m² μS≦500 mg/m², and the 10-point average roughness Rz of the transparent layer 16 satisfies 0.5 μm≦Rz≦1.0 μm, stable production can be made while rainbow-like unevenness are suppressed.

As for the translucent particles 15, those having two or more types of particle diameters may be mixed together for use. In particular, among two or more types of translucent particles, when a difference between at least two types in volume average particle diameter is larger than 1 μm, coagulation of particles is decreased. With this, dispersion property and the outer appearance of the film surface are improved.

Also, translucent particles 15 of two or more different materials may be used at the same time. For example, by changing the refractive index of each type of the particles, front luminance and mitigation of rainbow-like unevenness can be balanced, or the outer appearance of the film surface can be improved.

[Easily-Adhesive Layer]

The easily-adhesive layer 12 is provided on one surface of the support 11 in order to improve bondability of the support 11 to the prism layer 17 and increase adhesiveness to the prism layer 17.

The easily-adhesive layer 12 is normally formed by applying a coating fluid made of a binder, a curing agent, and a surface active agent onto the one surface of the support 11. As the material for use as the easily-adhesive layer 12, a suitable material is preferably selected for the purpose of increasing adhesiveness to the prism layer 17. Also, organic or inorganic fine particles may be contained in the easily-adhesive layer 12 as appropriate.

The binder used for the easily-adhesive layer 12 is not particularly restrictive. However, in view of adhesiveness, at least one of polyester, polyurethane, acrylic resin, and styrene-butadiene copolymer is preferable. Also, a water-soluble or water-dispersive binder is particularly preferable in view of less load on the environment.

The easily-adhesive layer 12 may include metal oxide particles exhibiting conductivity by electron conduction. As the metal oxide particles, general metal oxides can be used, and examples include ZnO, TiO₂, SnO₂, Al₂O₃, In₂O₃, MgO, BaO, MoO₃, and composite oxides thereof, and these metal oxides may contain a small amount of any different element. Among these metal oxides, SnO₂, ZnO, TiO₂, and In₂O₃ are preferable, and SnO₂ is particularly preferable. In place of the metal oxide particles exhibiting conductivity by electron conduction, a π electron-conjugated conductive polymer may be contained, such as a polythiophene-based polymer.

By adding metal oxide particles exhibiting conductivity by electron conduction or a π electron-conjugated conductive polymer to the easily-adhesive layer 12, the surface resistance of the easily-adhesive layer 12 is adjusted to be equal to or lower than 10¹² Ω/sq. With this, sufficient antistatic prevention can be achieved, thereby preventing absorption of dust and dirt onto the optical laminate films 10 and 20.

Fine particles made of metal oxide may be contained in the easily-adhesive layer 12 in order to adjust the refractive index of the easily-adhesive layer 12. As the metal oxide, metal oxide with a high refractive index is preferable, such as tin oxide, zirconium oxide, zinc oxide, titanium oxide, cerium oxide, or niobium oxide because metal oxide with a high refractive index can change the refractive index even with a small amount. The particle diameter of the fine particles made of metal oxide is preferably in a range of 1 nm to 50 nm, and particularly preferably in a range of 2 nm to 40 nm. Although the amount of the fine particles of metal oxide can be determined according to a target refractive index, the fine particles are preferably contained in the easily-adhesive layer 12 so that the mass of the fine particles is in a range of 10 to 90 when the total mass of the easily-adhesive layer 12 is assumed to be 100, and particularly preferably in a range of 30 to 80.

A thickness d₃ of the easily-adhesive layer 12 can be controlled by adjusting the amount of coating of the coating fluid forming the easily-adhesive layer 12. To exhibit excellent adhesiveness with highly transparency, the thickness d₃ is more preferable constant in a range of 0.01 μm to 5 μm. With the thickness d₃ being equal to or larger than 0.01 adhesiveness can be more reliably improved compared with the case in which the thickness is smaller than 0.01 μm. With the thickness d₃ being equal to or smaller than 5 μM, the easily-adhesive layer 12 having a more uniform thickness can be formed, compared with the case in which the thickness is larger than 5 μm. Furthermore, an increase in the amount of use of the coating fluid can be suppressed to prevent a protracted drying time, thereby suppressing an increase in cost. More preferably, the range of thickness d₃ of the easily-adhesive layer 12 is 0.02 μm to 3 μm.

[Lens Layer]

As a lens layer, a microlens layer, a prism layer, a lenticular lens layer, or others can be used. Among these, in particular, the prism layer is suitably used.

The prism layer 17 is formed by an embossing method or a cast polymerizing method. Normally, the cast polymerizing method with productivity higher than the embossing method is used.

In the cast polymerizing method, a film made of an UV-curable compound cured with ultraviolet rays (UV) is formed in a predetermined shape. With this shape being kept, the compound is cured with UV, thereby forming a plurality of columns of prisms having a predetermined sectional shape as the prism layer 17. When the prism layer 17 is formed by the cast polymerizing method, a material having a monomer, an oligomer, or a polymer with a double bond of radical polymerization as a main component is generally used and, furthermore, a polymerization initiator is contained. Examples of a monomer or an oligomer with a double bond of radical polymerization include an acrylic monomer and an acrylic oligomer. In view of mass productivity, the cast polymerizing method is more preferable than the embossing method and, a cast polymerizing method using an UV-curable compound is particularly preferable.

The prism layer 17 is formed on the easily-adhesive layer 12 of the support 11 in a subsequent process. Thus, in the optical laminate films 10 and 20, when light enters from the transparent layer 16 side, transmittance of light having a wavelength of 340 nm of incident light is preferably in a range equal to or larger than 70% and equal to or smaller than 100%. With this, the subsequent process for providing the prism layer 17 can be shortened as ever.

In general, a metal halide lamp for UV curing has a main luminous wavelength in a range of 340 nm to 400 nm, and the main luminous wavelength of a high-pressure mercury-vapor lamp is 365 nm. Also, the transmittance of an optical laminate film requiring transparency in a visible-light area tends to be decreased in the range of 340 nm to 400 nm as the wavelength is shorter. Therefore, the transmittance of light of at least 340 nm is preferably 70% to 100%. In particular, the transmittance of light is preferably 70% to 100% in the entire range of 340 nm to 400 nm. If the transmittance of light having a wavelength of 340 nm is smaller than 70%, when the prism layer 17 is provided on one surface of the support 11 by UV cuing, UV light emitted from a second transparent layer 14 side by using a metal halide lamp or a high-pressure mercury-vapor lamp is absorbed in the optical laminate films 10 and 20. With this absorption, the strength of UV light that can contribute to curing for forming the prism layer 17 is decreased. As a result, efficiency of curing the prism layer 17 is degraded. When efficiency of curing is degraded, the curing time is required to be extended until the layer becomes in a predetermined cured state, thereby decreasing productivity of optical films. Also, when the curing time is not desired to be extended, curing of the prism layer 17 is insufficient, and therefore the prism layer 17 is insufficient in anti-damage properties.

In both of the optical laminate films 10 and 20, when light enters from the transparent layer 16 side, transmittance of light having a wavelength of 365 nm of incident light is more preferably in a range equal to or larger than 76% and equal to or smaller than 100%. This is particularly effective when a high-pressure mercury-vapor lamp is used as a light source of radiation light for use in forming the prism layer 17, because an emission line of the high-pressure mercury-vapor lamp is of light of 365 nm.

### EXAMPLES

The present invention is described in more detail below with reference to examples and comparative examples of the present invention. However, these are not meant to be restrictive.

Examples based on the first embodiment are described.

### First Example

### Support

Polyethylene terephthalate (hereinafter referred to as “PET”) resin having an intrinsic viscosity of 0.66 subjected to polycondensation with a Ti compound as a catalyst was dried so as to have a water content equal to or smaller than 50 ppm, and was dissolved in an extruder with a heater temperature being set at 280° C. to 300° C. The dissolved PET resin was discharged from a die part onto an electrostatically-charged chill roll to obtain an amorphous base. The obtained amorphous base was drawn by a factor of 3.1 in a base running direction and then by a factor of 3.8 in a width direction to obtain a PET support having a thickness of 250 μm.

[Easily-Adhesive Layer]

The PET support (having a refractive index of 1.66) had one surface subjected to corona discharge process, and a coating fluid for the easily-adhesive layer formed of the composition described below was applied onto the support by the bar coat method. The amount of coating was 9.75 cc/m², and drying was performed at 145° C. for one minute. With this, an easily-adhesive layer A having a thickness of approximately 0.8 μm was formed on the support.

[Coating Fluid 1 for Easily-Adhesive Layer]

| | |
|---|---|
| Polyester resin binder | 124.0 parts by mass |
| (Manufactured by Goo Chemical Co., Ltd., | |
| Plascoat Z-687, solid content of 25%) | |
| Polyester resin binder | 106.9 parts by mass |
| (Manufactured by DIC Corporation, Finetex | |
| ES-650, solid content of 25%) | |
| Acrylic resin binder | 0.8 parts by mass |
| (Manufactured by Daicel Chemical | |
| Industries Ltd., EM48D, solid content | |
| of 27.5%) | |
| Compound having a plurality of carbodiimide | 31.0 parts by mass |
| structures (Manufactured by Nisshinbo | |
| Chemical, Inc., CARBODILITE V-02-L2, solid | |
| content of 40%) | |
| Oxazoline compound | 69.9 parts by mass |
| (Manufactured by Nippon Shokubai Co., Ltd., | |
| EPOCLOTH K2020E, solid content of 40%) | |
| Surface active agent A | 12.3 parts by mass |
| (Manufactured by NOF Corporation, 1% aqueous | |
| solution of Rapizol B-90, anionic) | |
| Surface active agent B | 29.7 parts by mass |
| (Manufactured by Sanyo Chemical Industries, | |
| Ltd., 1% aqueous solution of Naroacty CL-95, | |
| nonionic) | |
| PMMA spherical particles | 0.7 parts by mass |
| (Manufactured by Soken Chemical & Engineering | |
| Co., Ltd., water dispersion of MR-2G, solid | |
| content of 15%) | |
| Lubricant | 3.3 parts by mass |
| (Manufactured by Chukyo Yushi Co., Ltd., | |
| Serosol 524 of carnauba wax dispersion, | |
| solid content of 30%) | |
| Preservative | 1.1 parts by mass |
| (Manufactured by Daito Chemical Co., Ltd., | |
| AF-337, solid content of 3.5%, methanol | |
| solvent) | |
| Distilled Water | added so as to achieve |
| | 1000 parts by mass |
| | in total |

The PET support (having a refractive index of 1.66) had one surface subjected to corona discharge process, and a coating fluid 2 for the easily-adhesive layer formed of the composition described below was applied onto the support by the bar coat method. The amount of coating was 9.75 cc/m², and drying was performed at 145° C. for one minute. With this, an easily-adhesive layer B having a thickness of approximately 0.8 μm was formed on the support.

[Coating Fluid 2 for Easily-Adhesive Layer]

| | |
|---|---|
| Polyester resin binder | 141.1 parts by mass |
| (Manufactured by Goo Chemical Co., Ltd., | |
| Plascoat Z-592, solid content of 25%) | |
| Polyester resin binder | 121.6 parts by mass |
| (Manufactured by DIC Corporation, Finetex | |
| ES-650, solid content of 29%) | |
| Acrylic resin binder | 0.8 parts by mass |
| (Manufactured by Daicel Chemical Industries | |
| Ltd., EM48D, solid content of 27.5%) | |
| Oxazoline compound | 79.5 parts by mass |
| (Manufactured by Nippon Shokubai Co., Ltd., | |
| EPOCLOTH K2020E, solid content of 40%) | |
| Surface active agent A | 12.3 parts by mass |
| (Manufactured by NOF Corporation, 1% aqueous | |
| solution of Rapizol B-90, anionic) | |
| Surface active agent B | 29.7 parts by mass |
| (Manufactured by Sanyo Chemical Industries, | |
| Ltd., 1% aqueous solution of Naroacty CL-95, | |
| nonionic) | |
| PMMA spherical particles | 0.7 parts by mass |
| (Manufactured by Soken Chemical & Engineering | |
| Co., Ltd., water dispersion of MR-2G, solid | |
| content of 15%) | |
| Lubricant | 3.3 parts by mass |
| (Manufactured by Chukyo Yushi Co., Ltd., | |
| Serosol 524 of carnauba wax dispersion, | |
| solid content of 30%) | |
| Preservative | 1.1 parts by mass |
| (Manufactured by Daito Chemical Co., Ltd., | |
| AF-337, solid content of 3.5%, methanol | |
| solvent) | |
| Distilled Water | added so as to achieve |
| | 1000 parts by mass |
| | in total |

[First Transparent Layer]

After the easily-adhesive layer A was formed on one surface of the support, the coating fluid 1 for the first transparent layer formed of the composition described below was applied onto the other surface by the bar coat method. The amount of coating was 8.4 cc/m², and drying was performed at 145° C. for one minute. With this, the first transparent layer having an average film thickness of approximately 0.1 μm was formed on a side opposite to the surface where the easily-adhesive layer was formed.

[Coating Fluid 1 for First Transparent Layer]

| | |
|---|---|
| Self-crosslinking polyurethane resin binder | 35.0 parts by mass |
| (Manufactured by Mitsui Chemicals Inc., | |
| TAKELAC WS-5100, solid content of 30%) | |
| Tin dioxide-antimony-combined acicular metal | 43.7 parts by mass |
| oxide water dispersion (Manufactured by | |
| Ishihara Sangyo Kaisha Ltd., FS-10D, solid | |
| content of 20%) | |
| Surface active agent C | 2.1 parts by mass |
| (Manufactured by Sanyo Chemical Industries, Ltd., | |
| 10% aqueous solution of Sanded BL, anionic) | |
| Surface active agent B | 21.0 parts by mass |
| (Manufactured by Sanyo Chemical Industries, Ltd., | |
| 1% aqueous solution of Naroacty CL-95, nonionic) | |
| Distilled Water | added so as to |
| | achieve 1000 parts |
| | by mass in total |

[Second Transparent Layer]

Subsequently, a coating fluid for the second transparent layer formed of the composition described below was applied onto the first transparent layer by the bar coat method. The amount of coating was 7.1 cc/m², and drying was performed at 145° C. for one minute. With this, the second transparent layer having an average film thickness of approximately 0.7 μm was formed.

[Coating Fluid for Second Transparent Layer]

| | |
|---|---|
| Acetic-acid aqueous solution | 148.3 parts by mass |
| (Manufactured by Daicel Chemical Industries | |
| Ltd., | |
| 1% aqueous solution of industrial acetic acid) | |
| 3-glycidoxypropyltrimethoxysilane | 58.1 parts by mass |
| (Manufactured by Shin-Etsu Chemical Co., | |
| Ltd., KBE-403) | |
| Tetramethoxysilane | 67.3 parts by mass |
| (Manufactured by Shin-Etsu Chemical Co., | |
| Ltd., KBE-04) | |
| Colloidal silica | 591.4 parts by mass |
| (Manufactured by Nissan Chemical Industries | |
| Co., Ltd., SNOWTEX OS, solid content of | |
| 20%) | |
| Curing agent | 2.0 parts by mass |
| (Manufactured by Kawaken Fine Chemical Co., | |
| Ltd., Alumichelate A (W)) | |
| Surface active agent C | 17.7 parts by mass |
| (Manufactured by Sanyo Chemical Industries, | |
| Ltd., 10% aqueous solution of Sanded BL, | |
| anionic) | |
| Surface active agent B | 52.0 parts by mass |
| (Manufactured by Sanyo Chemical Industries, | |
| Ltd., 1% aqueous solution of Naroacty CL-95, | |
| nonionic) | |
| Acrylic resin fine particles | 14.1 parts by mass |
| (Manufactured by Soken Chemical & | |
| Engineering Co., Ltd., MX-150, average | |
| particle diameter of 1.5 μm) | |
| Distilled Water | added so as to achieve |
| | 1000 parts by mass |
| | in total |

Note that the coating fluid for the second transparent layer was prepared by the following method.

While the acetic-acid aqueous solution was being heavily stirred, 3-glycidoxypropyltrimethoxysilane was dropped into this acetic-acid aqueous solution for three minutes. Subsequently, tetraalkoxysilane was added to the acetic-acid aqueous solution while being heavily stirred for five minutes, and then stirring continued for two hours (this aqueous solution is referred to as an X fluid). The curing agent was added to colloidal silica, and stirring continued for two hours (this aqueous solution is referred to as a Y fluid). Also, the surface active agent, distilled water, and resin particles were added, and ultrasonic dispersion was performed for five minutes (this particle dispersion fluid is referred to as a Z fluid). The Y fluid, the surface active agent, the Z fluid, and distilled water were sequentially added to the X fluid.

[Lens Layer]

After the easily-adhesive layer A or B and the first and second transparent layers were formed on the support, a coating fluid for a prism layer described below was applied onto an easily-adhesive layer side by the bar coat method with a #24 bar. Then, after drying was performed at 60° C. for three minutes, a mold having a prism layer pattern molded thereon as a lens layer was pressed onto a prism layer coating surface, which was radiated with UV light (a metal halide lamp UVL-1500M2 manufactured by Ushio Inc.) from a support side on a condition of 2000 mJ/cm², thereby curing the resin. By peeling off the support from the mold, a prism layer having a vertical angle of 90° C., a pitch of 50 μm, and a height of 28 μm was formed.

[Prism-Layer Coating Fluid]

| | |
|---|---|
| Compound represented by Chemical Formula 1 below | 34.3 parts by mass |
| Compound represented by Chemical Formula 2 below | 13.7 parts by mass |
| Compound represented by Chemical Formula 3 below | 13.7 parts by mass |
| Compound represented by Chemical Formula 4 below | 6.9 parts by mass |
| Compound represented by Chemical Formula 5 below | 1.4 parts by mass |
| Methyl ethyl ketone | 15.0 parts by mass |
| Propyleneglycolmonomethylacetate | 15.0 parts by mass |

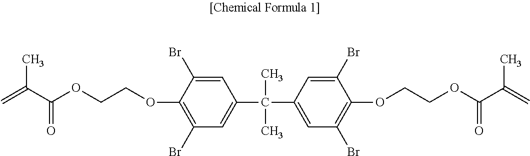

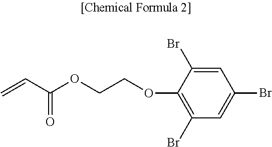

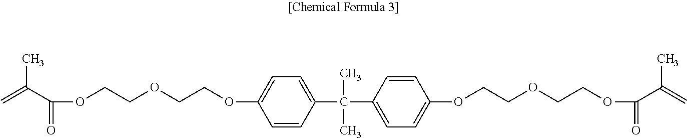

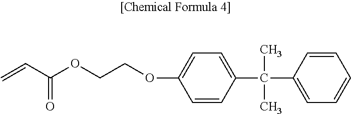

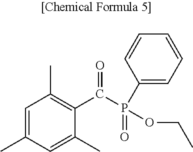

### Second Example

As a [coating fluid for the second transparent layer], in place of the one in the first example, a coating fluid for the second transparent layer formed of the composition described below was subsequently applied onto the first transparent layer by the bar coat method. The amount of coating was 9.4 cc/m², and drying was performed at 145° C. for one minute. With this, the second transparent layer having an average film thickness of approximately 0.9 μM was formed.

[Coating Fluid for Second Transparent Layer]

| | |
|---|---|
| Acetic-acid aqueous solution | 136.0 parts by mass |
| (Manufactured by Daicel Chemical Industries | |
| Ltd., | |
| 1% aqueous solution of industrial acetic acid) | |
| 3-glycidoxypropyltrimethoxysilane | 53.2 parts by mass |
| (Manufactured by Shin-Etsu Chemical Co., | |
| Ltd., KBE-403) | |
| Tetramethoxysilane | 61.8 parts by mass |
| (Manufactured by Shin-Etsu Chemical Co., | |
| Ltd., KBE-04) | |
| Colloidal silica | 542.4 parts by mass |
| (Manufactured by Nissan Chemical Industries | |
| Co., Ltd., SNOWTEX OS, solid content of 20%) | |
| Curing agent | 1.8 parts by mass |
| (Manufactured by Kawaken Fine Chemical Co., | |
| Ltd., Alumichelate A (W)) | |
| Surface active agent C (Manufactured | 20.6 parts by mass |
| by Sanyo Chemical Industries, Ltd., | |
| 10% aqueous solution of Sanded BL, anionic) | |
| Surface active agent B (Manufactured | 60.0 parts by mass |
| by Sanyo Chemical Industries, Ltd., 1% | |
| aqueous solution of Naroacty CL-95, nonionic) | |
| Polystyrene resin fine particles | 6.2 parts by mass |
| (Manufactured by Soken Chemical & | |
| Engineering Co., Ltd., MP5000, average | |
| particle diameter of 0.4 μm) | |
| Polystyrene resin fine particles | 6.2 parts by mass |
| (Manufactured by Soken Chemical & | |
| Engineering Co., Ltd., SX130H, average | |
| particle diameter of 1.3 μm) | |
| Water-dispersing element of polystyrene resin | 31.2 parts by mass |
| fine particles (Manufactured by Zeon | |
| Corporation, Nippol UFN1008, solid content of | |
| 20%, average particle diameter of 1.8 μm) | |
| Distilled Water | added so as to achieve |
| | 1000 parts by mass |
| | in total |

### Third Example

As a [coating fluid for the second transparent layer], in place of the one in the first example, a coating fluid for the second transparent layer formed of the composition described below was subsequently applied on the first transparent layer by the bar coat method. The amount of coating was 28.2 cc/m², and drying was performed at 145° C. for two minutes. With this, the second transparent layer having an average film thickness of approximately 2.2 μm was formed.

[Coating Fluid for Second Transparent Layer]

| | |
|---|---|
| Acetic-acid aqueous solution | 136.0 parts by mass |
| (Manufactured by Daicel Chemical Industries | |
| Ltd., 1% aqueous solution of industrial acetic | |
| acid) | |
| 3-glycidoxypropyltrimethoxysilane | 53.2 parts by mass |
| (Manufactured by Shin-Etsu Chemical Co., | |
| Ltd., KBE-403) | |
| Tetramethoxysilane | 61.8 parts by mass |
| (Manufactured by Shin-Etsu Chemical Co., | |
| Ltd., KBE-04) | |
| Colloidal silica | 542.4 parts by mass |
| (Manufactured by Nissan Chemical Industries | |
| Co., Ltd., SNOWTEX OS, solid content of 20%) | |
| Curing agent | 1.8 parts by mass |
| (Manufactured by Kawaken Fine Chemical Co., | |
| Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 60.0 parts by mass |
| (Manufactured by Sanyo Chemical Industries, | |
| Ltd., 1% aqueous solution of Naroacty CL-95, | |
| nonionic) | |
| Acrylic resin fine particles | 10.7 parts by mass |
| (Manufactured by Soken Chemical & | |
| Engineering Co., Ltd., MX-300, average particle | |
| diameter of 3.0 μm) | |
| Distilled Water | added so as to achieve |
| | 1000 parts by mass |
| | in total |

### Fourth Example

As a [coating fluid for the second transparent layer], in place of the one in the first example, a coating fluid for the second transparent layer formed of the composition described below was subsequently applied on the first transparent layer by the bar coat method. The amount of coating was 7.8 cc/m², and drying was performed at 145° C. for one minute. With this, the second transparent layer having an average film thickness of approximately 0.8 μm was formed.

[Coating Fluid for Second Transparent Layer]

| | |
|---|---|
| Acetic-acid aqueous solution | 136.0 parts by mass |
| (Manufactured by Daicel Chemical Industries | |
| Ltd., 1% aqueous solution of industrial acetic | |
| acid) | |
| 3-glycidoxypropyltrimethoxysilane | 53.2 parts by mass |
| (Manufactured by Shin-Etsu Chemical Co., Ltd., | |
| KBE-403) | |
| Tetramethoxysilane | 61.8 parts by mass |
| (Manufactured by Shin-Etsu Chemical Co., Ltd., | |
| KBE-04) | |
| Colloidal silica | 542.4 parts by mass |
| (Manufactured by Nissan Chemical Industries | |
| Co., Ltd., SNOWTEX OS, solid content of 20%) | |
| Curing agent | 1.8 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 60.0 parts by mass |
| (Manufactured by Sanyo Chemical Industries, | |
| Ltd., 1% aqueous solution of Naroacty CL-95, | |
| nonionic) | |
| Acrylic resin fine particles | 4.3 parts by mass |
| (Manufactured by Soken Chemical & Engineering | |
| Co., Ltd., MX80H3WT, average particle diameter | |
| of 0.8 μm) | |
| Acrylic resin fine particles | 4.3 parts by mass |
| (Manufactured by Soken Chemical & Engineering | |
| Co., Ltd., MX150, average particle diameter | |
| of 1.5 μm) | |
| Acrylic resin fine particles | 4.3 parts by mass |
| (Manufactured by Soken Chemical & Engineering | |
| Co., Ltd., MX-180, average particle diameter of | |
| 1.8 μm) | |
| Distilled Water | added so as to |
| | achieve 1000 parts |
| | by mass in total |

### Fifth Example

As a [coating fluid for the second transparent layer], in place of the one in the first example, a coating fluid for the second transparent layer formed of the composition described below was subsequently applied on the first transparent layer by the bar coat method. The amount of coating was 3.4 cc/m², and drying was performed at 145° C. for one minute. With this, the second transparent layer having an average film thickness of approximately 0.7 μm was formed.

| | |
|---|---|
| MEK (methyl ethyl ketone) | 800.0 parts by mass |
| Acrylic monomer | 186 parts by mass |
| (Manufactured by Nippon Kayaku Co., Ltd., | |
| KAYARAD DPCA20) | |
| Acrylic resin fine particles | 8.5 parts by mass |
| (Manufactured by Soken Chemical & Engineering | |
| Co., Ltd., MX-180, average particle diameter | |
| of 1.8 μm) | |
| Ultraviolet curing resin | 5.5 parts by mass |
| (Manufactured by Ciba Specialty Chemicals | |
| Inc., Irg184) | |

This fluid was stirred for use after mixing.

After coating, drying was performed at 60° C. for one minute, and then UV light (a metal halide lamp UVL-1500M2 manufactured by Ushio Inc.) was applied from a coating surface side on a condition of 2000 mJ/cm², thereby curing the resin.

### Sixth Example

As a [coating fluid for the second transparent layer], in place of the one in the first example, a coating fluid for the second transparent layer formed of the composition below was subsequently applied on the first transparent layer by the bar coat method. The amount of coating was 10.4 cc/m², and drying was performed at 145° C. for one minute. With this, the second transparent layer having an average film thickness of approximately 1.2 μm was formed.

[Coating Fluid for Second Transparent Layer]

| | |
|---|---|
| Acetic-acid aqueous solution | 144.3 parts by mass |
| (Manufactured by Daicel Chemical Industries | |
| Ltd., 1% aqueous solution of industrial acetic | |
| acid) | |
| 3-glycidoxypropyltrimethoxysilane | 56.5 parts by mass |
| (Manufactured by Shin-Etsu Chemical Co., | |
| Ltd., KBE-403) | |
| Tetramethoxysilane | 65.5 parts by mass |
| (Manufactured by Shin-Etsu Chemical Co., | |
| Ltd., KBE-04) | |
| Colloidal silica | 575.1 parts by mass |
| (Manufactured by Nissan Chemical Industries | |
| Co., Ltd., SNOWTEX OS, solid content of 20%) | |
| Curing agent | 1.9 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 57.2 parts by mass |
| (Manufactured by Sanyo Chemical Industries, | |
| Ltd., 1% aqueous solution of Naroacty CL-95, | |
| nonionic) | |
| Water-dispersing element of polystyrene resin | 87.0 parts by mass |
| fine particles (Manufactured by Zeon | |
| Corporation, Nippol UFN1008, solid content of | |
| 20%, average particle diameter of 1.8 μm) | |
| Distilled Water | added so as to achieve |
| | 1000 parts by |
| | mass in total |

### Seventh Example

As a [coating fluid for the second transparent layer], in place of the one in the first example, a coating fluid for the second transparent layer formed of the composition below was subsequently applied on the first transparent layer by the bar coat method. The amount of coating was 10.4 cc/m², and drying was performed at 145° C. for one minute. With this, the second transparent layer having an average film thickness of approximately 1.0 μm was formed.

[Coating Fluid for Second Transparent Layer]

| | |
|---|---|
| Acetic-acid aqueous solution | 122.5 parts by mass |
| (Manufactured by Daicel Chemical Industries | |
| Ltd., 1% aqueous solution of industrial acetic | |
| acid) | |
| 3-glycidoxypropyltrimethoxysilane | 48.0 parts by mass |
| (Manufactured by Shin-Etsu Chemical Co., Ltd., | |
| KBE-403) | |
| Tetramethoxysilane | 55.6 parts by mass |
| (Manufactured by Shin-Etsu Chemical Co., Ltd., | |
| KBE-04) | |
| Colloidal silica | 488.9 parts by mass |
| (Manufactured by Nissan Chemical Industries | |
| Co., Ltd., SNOWTEX OS, solid content of 20%) | |
| Curing agent | 1.6 parts by mass |
| (Manufactured by Kawaken Fine Chemical | |
| Co., Ltd., Alumichelate A (W)) | |
| Surface active agent C | 18.6 parts by mass |
| (Manufactured by Sanyo Chemical Industries, | |
| Ltd., 10% aqueous solution of Sanded BL, | |
| anionic) | |
| Surface active agent B | 60.2 parts by mass |
| (Manufactured by Sanyo Chemical Industries, | |
| Ltd., 1% aqueous solution of Naroacty CL-95, | |
| nonionic) | |
| Acrylic resin fine particles | 7.2 parts by mass |
| (Manufactured by Soken Chemical & Engineering | |
| Co., Ltd., MX80H3WT, average | |
| particle diameter of 0.8 μm) | |
| Polystyrene resin fine particles | 7.2 parts by mass |
| (Manufactured by Soken Chemical & Engineering | |
| Co., Ltd., SX130H, average particle diameter | |
| of 1.3 μm) | |
| Water-dispersing element of polystyrene resin | 36.0 parts by mass |
| fine particles (Manufactured by Zeon | |
| Corporation, Nippol UFN1008, solid content | |
| of 20%, average particle diameter of 1.8 μm) | |
| Distilled Water | added so as to achieve |
| | 1000 parts by |
| | mass in total |

### Eighth Example

As a [coating fluid for the second transparent layer], in place of the one in the first example, a coating fluid for the second transparent layer formed of the composition below was subsequently applied on the first transparent layer by the bar coat method. The amount of coating was 10.4 cc/m², and drying was performed at 145° C. for one minute. With this, the second transparent layer having an average film thickness of approximately 1.0 μm was formed.

[Coating Fluid for Second Transparent Layer]

| | |
|---|---|
| Acetic-acid aqueous solution | 122.5 parts by mass |
| (Manufactured by Daicel Chemical Industries | |
| Ltd., 1% aqueous solution of industrial acetic | |
| acid) | |
| 3-glycidoxypropyltrimethoxysilane | 48.0 parts by mass |
| (Manufactured by Shin-Etsu Chemical Co., Ltd., | |
| KBE-403) | |
| Tetramethoxysilane | 55.6 parts by mass |
| (Manufactured by Shin-Etsu Chemical Co., Ltd., | |
| KBE-04) | |
| Colloidal silica | 488.9 parts by mass |
| (Manufactured by Nissan Chemical Industries | |
| Co., Ltd., SNOWTEX OS, solid content of 20%) | |
| Curing agent | 1.6 parts by mass |
| (Manufactured by Kawaken Fine Chemical Co., | |
| Ltd., Alumichelate A (W)) | |
| Surface active agent C | 18.6 parts by mass |
| (Manufactured by Sanyo Chemical Industries, | |
| Ltd., 10% aqueous solution of Sanded BL, | |
| anionic) | |
| Surface active agent B | 60.2 parts by mass |
| (Manufactured by Sanyo Chemical Industries, | |
| Ltd., 1% aqueous solution of Naroacty | |
| CL-95, nonionic) | |
| Acrylic resin fine particles | 7.2 parts by mass |
| (Manufactured by Soken Chemical & Engineering | |
| Co., Ltd., MX80H3WT, average particle | |
| diameter of 0.8 μm) | |
| Acrylic resin fine particles | 7.2 parts by mass |
| (Manufactured by Soken Chemical & Engineering | |
| Co., Ltd., MX150, average particle diameter | |
| of 1.5 μm) | |
| Water-dispersing element of polystyrene resin | 36.0 parts by mass |
| fine particles (Manufactured by Zeon | |
| Corporation, Nippol UFN1008, solid content | |
| of 20%, average particle diameter of 1.8 μm) | |
| Distilled Water | added so as to achieve |
| | 1000 parts by |
| | mass in total |

### Ninth Example

As a [coating fluid for the second transparent layer], in place of the one in the first example, a coating fluid for the second transparent layer formed of the composition below was subsequently applied on the first transparent layer by the bar coat method. The amount of coating was 2.2 cc/m², and drying was performed at 145° C. for one minute. With this, the second transparent layer having an average film thickness of approximately 0.2 μm was formed.

[Coating Fluid for Second Transparent Layer]

| | |
|---|---|
| Acetic-acid aqueous solution | 136.7 parts by mass |
| (Manufactured by Daicel Chemical Industries | |
| Ltd., 1% aqueous solution of industrial acetic | |
| acid) | |
| 3-glycidoxypropyltrimethoxysilane | 53.5 parts by mass |
| (Manufactured by Shin-Etsu Chemical Co., Ltd., | |
| KBE-403) | |
| Tetramethoxysilane | 62.0 parts by mass |
| (Manufactured by Shin-Etsu Chemical Co., Ltd., | |
| KBE-04) | |
| Colloidal silica | 545.3 parts by mass |
| (Manufactured by Nissan Chemical Industries | |
| Co., | |
| Ltd., SNOWTEX OS, solid content of 20%) | |
| Curing agent | 1.8 parts by mass |
| (Manufactured by Kawaken Fine Chemical Co., | |
| Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 60.0 parts by mass |
| (Manufactured by Sanyo Chemical Industries, | |
| Ltd., 1% aqueous solution of Naroacty CL-95, | |
| nonionic) | |
| Polystyrene resin fine particles | 91.0 parts by mass |
| (Manufactured by Soken Chemical & Engineering | |
| Co., Ltd., MP5000, average particle diameter | |
| of 0.4 μm) | |
| Distilled Water | added so as to achieve |
| | 1000 parts by |
| | mass in total |

### Tenth Example

As a [coating fluid for the second transparent layer], in place of the one in the first example, a coating fluid for the second transparent layer formed the composition described below was subsequently applied on the first transparent layer by the bar coat method. The amount of coating was 26.6 cc/m², and drying was performed at 145° C. for two minutes. With this, the second transparent layer having an average film thickness of approximately 2.4 μm was formed.

[Coating Fluid for Second Transparent Layer]

| | |
|---|---|
| Acetic-acid aqueous solution | 136.0 parts by mass |
| (Manufactured by Daicel Chemical Industries | |
| Ltd., 1% aqueous solution of industrial acetic | |
| acid) | |
| 3-glycidoxypropyltrimethoxysilane | 53.2 parts by mass |
| (Manufactured by Shin-Etsu Chemical Co., Ltd., | |
| KBE-403) | |
| Tetramethoxysilane | 61.8 parts by mass |
| (Manufactured by Shin-Etsu Chemical Co., Ltd., | |
| KBE-04) | |
| Colloidal silica | 542.4 parts by mass |
| (Manufactured by Nissan Chemical Industries | |
| Co., Ltd., SNOWTEX OS, solid content of 20%) | |
| Curing agent | 1.8 parts by mass |
| (Manufactured by Kawaken Fine Chemical Co., | |
| Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 70.0 parts by mass |
| (Manufactured by Sanyo Chemical Industries, | |
| Ltd., 1% aqueous solution of Naroacty | |
| CL-95, nonionic) | |
| Acrylic resin fine particles | 18.7 parts by mass |
| (Manufactured by Soken Chemical & Engineering | |
| Co., Ltd., MX-300, average particle diameter | |
| of 3.0 μm) | |
| Distilled Water | added so as to achieve |
| | 1000 parts by |
| | mass in total |

### Eleventh Example

As a [coating fluid for the second transparent layer], in place of the one in the first example, a coating fluid for the second transparent layer formed of the composition described below was subsequently applied on the first transparent layer by the bar coat method. The amount of coating was 1.0 cc/m², and drying was performed at 145° C. for one minute. With this, the second transparent layer having an average film thickness of approximately 0.1 μm was formed.

| | |
|---|---|
| MEK (methyl ethyl ketone) | 868.2 parts by mass |
| Polyfunctional acrylic monomer | 60.0 parts by mass |
| (Manufactured by Nippon Kayaku Co., Ltd., | |
| KAYARAD DPCA20) | |
| Acrylic resin fine particles | 70.0 parts by mass |
| (Manufactured by Soken Chemical & Engineering | |
| Co., Ltd., MX80H3WT, average particle | |
| diameter of 0.8 μm) | |
| Ultraviolet curing resin | 1.8 parts by mass |
| (Manufactured by Ciba Specialty Chemicals | |
| Inc., Irg184) | |

After mixing, this fluid was agitated for use.

After coating, drying was performed at 60° C. for one minute, and then UV light (a metal halide lamp UVL-1500M2 manufactured by Ushio Inc.) was applied from a coating surface side on a condition of 2000 mJ/cm², thereby curing the resin.

### Twelfth Example

After the easily-adhesive layer B was formed on one surface of the support, the coating fluid 1 for the first transparent layer formed of the composition described below was applied onto the other surface by the bar coat method. The amount of coating was 8.4 cc/m², and drying was performed at 145° C. for one minute. With this, the first transparent layer having an average film thickness of approximately 0.1 μm was formed on a side opposite to the surface where the easily-adhesive layer was formed. Subsequently, as a [coating fluid for the second transparent layer], the coating fluid for the second transparent layer described in the eighth example was subsequently applied on the first transparent layer by the bar coat method. The amount of coating was 10.4 cc/m², and drying was performed at 145° C. for one minute. With this, the second transparent layer having an average film thickness of approximately 1.0 μm was formed.

### First Comparative Example

As a [coating fluid for the second transparent layer], in place of the one in the first example, a coating fluid for the second transparent layer formed of the composition described below was subsequently applied on the first transparent layer by the bar coat method. The amount of coating was 7.1 cc/m², and drying was performed at 145° C. for two minutes. With this, the second transparent layer having an average film thickness of approximately 0.7 μm was formed.

[Coating Fluid for Second Transparent Layer]

| | |
|---|---|
| Acetic-acid aqueous solution | 136.0 parts by mass |
| (Manufactured by Daicel Chemical Industries | |
| Ltd., 1% aqueous solution of industrial acetic | |
| acid) | |
| 3-glycidoxypropyltrimethoxysilane | 53.2 parts by mass |
| (Manufactured by Shin-Etsu Chemical Co., Ltd., | |
| KBE-403) | |
| Tetramethoxysilane | 61.8 parts by mass |
| (Manufactured by Shin-Etsu Chemical Co., Ltd., | |
| KBE-04) | |
| Colloidal silica | 542.4 parts by mass |
| (Manufactured by Nissan Chemical Industries | |
| Co., Ltd., SNOWTEX OS, solid content of 20%) | |
| Curing agent | 1.8 parts by mass |
| (Manufactured by Kawaken Fine Chemical Co., | |
| Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 60.0 parts by mass |
| (Manufactured by Sanyo Chemical Industries, | |
| Ltd., 1% aqueous solution of Naroacty | |
| CL-95, nonionic) | |
| Acrylic resin fine particles | 3.6 parts by mass |
| (Manufactured by Soken Chemical & Engineering | |
| Co., Ltd., MX-150, average particle diameter | |
| of 1.5 μm) | |
| Distilled Water | added so as to achieve |
| | 1000 parts by |
| | mass in total |

### Second Comparative Example

As a [coating fluid for the second transparent layer], in place of the one in the first example, a coating fluid for the second transparent layer formed of the composition described below was subsequently applied on the first transparent layer by the bar coat method. The amount of coating was 24.3 cc/m², and drying was performed at 145° C. for two minutes. With this, the second transparent layer having an average film thickness of approximately 2.3 μm was formed.

[Coating Fluid for Second Transparent Layer]

| | |
|---|---|
| Acetic-acid aqueous solution | 136.1 parts by mass |
| (Manufactured by Daicel Chemical Industries | |
| Ltd., 1% aqueous solution of industrial acetic | |
| acid) | |
| 3-glycidoxypropyltrimethoxysilane | 53.3 parts by mass |
| (Manufactured by Shin-Etsu Chemical Co., Ltd., | |
| KBE-403) | |
| Tetramethoxysilane | 61.3 parts by mass |
| (Manufactured by Shin-Etsu Chemical Co., Ltd., | |
| KBE-04) | |
| Colloidal silica | 543.1 parts by mass |
| (Manufactured by Nissan Chemical Industries | |
| Co., Ltd., SNOWTEX OS, solid content of 20%) | |
| Curing agent | 1.8 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 60.0 parts by mass |
| (Manufactured by Sanyo Chemical Industries, | |
| Ltd., 1% aqueous solution of Naroacty CL-95, | |
| nonionic) | |
| Acrylic resin fine particles | 29 parts by mass |
| (Manufactured by Soken Chemical & Engineering | |
| Co., Ltd., MX-300, average particle diameter | |
| of 3.0 μm) | |
| Distilled Water | added so as to achieve |
| | 1000 parts by |
| | mass in total |

### Third Comparative Example

As a [coating fluid for the second transparent layer], in place of the one in the first example, a coating fluid for the second transparent layer formed of the composition described below was subsequently applied on the first transparent layer by the bar coat method. The amount of coating was 2.2 cc/m², and drying was performed at 145° C. for two minutes. With this, the second transparent layer having an average film thickness of approximately 0.2 μm was formed.

[Coating Fluid for Second Transparent Layer]

| | |
|---|---|
| Acetic-acid aqueous solution | 136.7 parts by mass |
| (Manufactured by Daicel Chemical Industries | |
| Ltd., 1% aqueous solution of industrial | |
| acetic acid) | |
| 3-glycidoxypropyltrimethoxysilane | 53.5 parts by mass |
| (Manufactured by Shin-Etsu Chemical Co., Ltd., | |
| KBE-403) | |
| Tetramethoxysilane | 62.1 parts by mass |
| (Manufactured by Shin-Etsu Chemical Co., Ltd., | |
| KBE-04) | |
| Colloidal silica | 545.3 parts by mass |
| (Manufactured by Nissan Chemical Industries | |
| Co., Ltd., SNOWTEX OS, solid content of 20%) | |
| Curing agent | 1.8 parts by mass |
| (Manufactured by Kawaken Fine Chemical Co., | |
| Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 60.0 parts by mass |
| (Manufactured by Sanyo Chemical Industries, | |
| Ltd., 1% aqueous solution of Naroacty | |
| CL-95, nonionic) | |
| Acrylic resin fine particles | 32.0 parts by mass |
| (Manufactured by Soken Chemical & Engineering | |
| Co., Ltd., MX-150, average particle diameter | |
| of 1.5 μm) | |
| Distilled Water | added so as to achieve |
| | 1000 parts by |
| | mass in total |

### Fourth Comparative Example

As a [coating fluid for the second transparent layer], in place of the one in the first example, a coating fluid for the second transparent layer formed of the composition described below was subsequently applied on the first transparent layer by the bar coat method. The amount of coating was 32.0 cc/m², and drying was performed at 145° C. for two minutes. With this, the second transparent layer having an average film thickness of approximately 8 μM was formed.

[Coating Fluid for Second Transparent Layer]

| | |
|---|---|
| Surface active agent | 1.8 parts by mass |
| (Manufactured by Sanyo Chemical | |
| Industries, Ltd., Naroacty CL-95) | |
| Polystyrene fine particles | 12.3 parts by mass |
| (Manufactured by Sekisui Plastics Co., Ltd., | |
| SBX-4, polystyrene particles, average | |
| particle diameter of 4 μm) | |
| Water-dispersing polymer | 708.0 parts by mass |
| (polyurethane resin, manufactured by Mitsui | |
| Chemicals Inc., TAKELAC W6010, solid | |
| content of 30%) | |
| Crosslinking agent | 44.2 parts by mass |
| (Manufactured by Nisshinbo Chemical, Inc., | |
| CARBODILITE V-02-L2, solid content of | |
| 40%) | |
| Distilled Water | added so as to achieve 1000 |
| | parts by mass in total |

This fluid was stirred for use after mixing.

### [Evaluation]

The optical laminate films obtained in the first to twelfth examples and the first to fourth comparative examples were evaluated as follows.

[Haze value]

In the examples of the optical laminate film 10, a haze meter (NDH-2000, Nippon Denshoku Industries Co., Ltd.) was used, and hazes were measured according to JIS-K-7105.

Note that in the examples of the optical laminate film 20, a measurement can be performed with the film being completely flattened with a fluid having a refractive index equal to that of the lens layer (such as matching oil).

[Volume Average Particle Diameter]

With an optical microscope, a diameter Di of each of particles and the number of particles ni were measured within a range of 1 cm², and a volume average particle r was calculated as r=Σ(Di×Di³×ni)/Σ(Di³×ni).

Also, when a measurement with the optical microscope was difficult, a SEM or the like was used as appropriate to calculate a particle diameter from images of the surface and section of the film.

[Amount of Addition of Translucent Particles]

Measurements were performed with a method similar to that for measuring a volume average particle diameter. With a relative density of each particle being taken as Ai, the amount of addition was calculated as S (mg)=10×47π/3×Σ{Ai×ni×(Di/2)³}.

[Average Film Thickness of Transparent Layer]

A sectional photograph of the film was shot by SEW with the number of items allowing the film thickness to be measured without variation, the thickness of each part was measured, and the obtained values were averaged to find an average film thickness.

[10-Point Average Roughness]

10-point average roughness (Rz) was set by using a stylus-type surface roughness measuring instrument “HANDY SURF E-35B” (manufactured by Tokyo Seimitsu Co., Ltd.) according to JIS B-0601 (1994), and values derived from the surface roughness measuring instrument were adopted.

[Rainbow-Like Unevenness]

The backlight of BRAVIA (KDL-40NX800) manufactured by SONY Corporation was taken out so that the backlight can be lit up, and each sample was arranged on the backlight, with the prism layer being placed outside. Then, evaluation was visually made as to the degree of color unevenness in a boundary region between a bright part and a dark part viewed in a direction perpendicular to a direction in which the prisms of the prism layer is on a line and when a line of sight is titled at approximately 30° from a straight above direction.

A: Little unevenness can be viewed.
B: Slight unevenness can be viewed.
C: Significant unevenness can be viewed.

[Particle Missing]

With an abrasion-resistance test machine (manufactured by SHINTO Scientific Co., Ltd.), missing or falling of particles (particle missing, or particle falling) were evaluated. Specifically, black paper (manufactured by FUJI FILM Corporation, SKBT 3 90BIG0) was brought into contact with a coating surface on a back surface side and, with a load of 3 kg per 30 mm×25 mm being applied, the surface was rubbed for a distance of 10 cm at 100 cm/minute. After the rubbing test, a level of white powder attached onto the black paper was visually evaluated.

A: A trace amount of white powder or none is attached.
B: A slight amount of white powder is attached.
C: A significant amount of white powder is attached.

Table 1 summarizes conditions and evaluation results of examples and comparative examples. In the first to twelfth examples, since the volume average particle diameter r of the translucent particles satisfies 0.4 μm≦r≦3.0 μm, the total sum S satisfies 30 mg/m²≦S≦500 mg/m², and the average film thickness t of the transparent layer satisfies r/4≦t<r, evaluations of rainbow-like unevenness and particle missing were B or higher.

In the first comparative example, the addition amount of particles is smaller than 30 mg/m², evaluation of rainbow-like unevenness is marked with C. In the second comparative example, since the addition amount S of transparent particles is large, particle missing is marked with C. In the third comparative example, since the average film thickness t is smaller than ¼ of the volume average particle diameter r, particle missing is marked with C. In the fourth comparative example, the volume average particle diameter r is larger than 3.0 μm and the average film thickness t is larger than the volume average particle diameter r even with a haze value of 31%, and therefore evaluation of rainbow-like unevenness is marked with C.

TABLE 1

| | | VOLUME | AMOUNT OF | AVERAGE FILM | 10-POINT | | |
|---|---|---|---|---|---|---|---|
| | HAZE | AVERAGE | ADDITION OF | THICKNESS OF | AVERAGE | | |
| | VALUE | PARTICLE | PARTICLES | TRANSPARENT | ROUGHNESS | RAINBOW-LIKE | PARTICLE |
| | (%) | DIAMETER (μm) | (mg/m²) | LAYER (μm) | (μm) | UNEVENNESS | MISSING |
| EXAMPLE 1 | 35 | 1.5 | 100 | 0.9 | 0.8 | A | A |
| EXAMPLE 2 | 42 | 1.1 | 180 | 1.0 | 0.7 | A | A |
| EXAMPLE 3 | 40 | 3.0 | 300 | 2.3 | 0.8 | A | A |
| EXAMPLE 4 | 29 | 1.4 | 100 | 1.0 | 0.9 | A | A |
| EXAMPLE 5 | 20 | 1.5 | 30 | 0.8 | 0.9 | A | A |
| EXAMPLE 6 | 43 | 1.8 | 180 | 1.3 | 0.5 | B | A |
| EXAMPLE 7 | 43 | 1.3 | 225 | 1.1 | 0.6 | A | A |
| EXAMPLE 8 | 40 | 1.4 | 225 | 1.1 | 0.7 | A | A |
| EXAMPLE 9 | 55 | 0.4 | 200 | 0.3 | 0.7 | B | A |
| EXAMPLE 10 | 60 | 3.0 | 500 | 2.5 | 0.8 | A | B |
| EXAMPLE 11 | 30 | 0.8 | 70 | 0.2 | 0.7 | A | B |
| EXAMPLE 12 | 40 | 1.4 | 225 | 1.1 | 0.7 | A | A |
| COMPARATIVE | 11 | 1.5 | 25 | 0.8 | 0.7 | C | A |
| EXAMPLE 1 | | | | | | | |
| COMPARATIVE | −90 | 3.0 | 700 | 2.3 | −0.9 | A | C |
| EXAMPLE 2 | | | | | | | |
| COMPARATIVE | −40 | 1.5 | 700 | 0.3 | −1.2 | A | C |
| EXAMPLE 3 | | | | | | | |
| COMPARATIVE | 31 | 4.0 | 400 | 8.0 | 0.3 | C | A |
| EXAMPLE 4 | | | | | | | |

Examples based on the second embodiment are described.

### Thirteenth Example

### Support

Polyethylene terephthalate (hereinafter referred to as “PET”) resin having an intrinsic viscosity of 0.66 subjected to polycondensation with a Ti compound as a catalyst was dried so as to have a water content equal to or smaller than 50 ppm, and was dissolved in an extruder with a heater temperature being set at 280° C. to 300° C. The dissolved PET resin was discharged from a die part onto an electrostatically-charged chill roll to obtain an amorphous base. The obtained amorphous base was drawn by a factor of 3.1 in a base running direction and then by a factor of 3.8 in a width direction to obtain a PET support having a thickness of 250 μm.

[Easily-Adhesive Layer]

The PET support (having a refractive index of 1.66) had one surface subjected to corona discharge process, and a coating fluid for the easily-adhesive layer formed of the composition described below was applied onto the support by the bar coat method. The amount of coating was 9.75 cc/m², and drying was performed at 145° C. for one minute. With this, an easily-adhesive layer A having a thickness of approximately 0.8 μm was formed on the support.

[Coating Fluid 1 for Easily-Adhesive Layer]

| | |
|---|---|
| Polyester resin binder | 124.0 parts by mass |
| (Manufactured by Goo Chemical Co., Ltd., | |
| Plascoat Z-687, solid content of 25%) | |
| Polyester resin binder | 106.9 parts by mass |
| (Manufactured by DIC Corporation, Finetex | |
| ES-650, solid content of 29%) | |
| Acrylic resin binder | 0.8 parts by mass |
| (Manufactured by Daicel Chemical Industries | |
| Ltd., EM48D, solid content of 27.5%) | |
| Compound having a plurality of carbodiimide | 31.0 parts by mass |
| structures (Manufactured by Nisshinbo | |
| Chemical, Inc., CARBODILITE V-02-L2, | |
| solid content of 40%) | |
| Oxazoline compound | 69.9 parts by mass |
| (Manufactured by Nippon Shokubai Co., Ltd., | |
| EPOCLOTH K2020E, solid content of 40%) | |
| Surface active agent A | 12.3 parts by mass |
| (Manufactured by NOF Corporation, 1% | |
| aqueous solution of Rapizol B-90, anionic) | |
| Surface active agent B | 29.7 parts by mass |
| (Manufactured by Sanyo Chemical Industries, | |
| Ltd., 1% aqueous solution of Naroacty | |
| CL-95, nonionic) | |
| PMMA spherical particles | 0.7 parts by mass |
| (Manufactured by Soken Chemical & | |
| Engineering Co., Ltd., water dispersion of | |
| MR-2G, solid content of 15%) | |
| Lubricant | 3.3 parts by mass |
| (Manufactured by Chukyo Yushi Co., Ltd., | |
| Serosol 524 of carnauba wax dispersion, | |
| solid content of 30%) | |
| Preservative | 1.1 parts by mass |
| (Manufactured by Daito Chemical Co., Ltd., | |
| AF-337, solid content of 3.5%, | |
| methanol solvent) | |
| Distilled Water | added so as to achieve |
| | 1000 parts by |
| | mass in total |

[First Transparent Layer]

After the easily-adhesive layer was formed on one surface of the support, the coating fluid 1 for the first transparent layer formed of the composition described below was applied onto the other surface by the bar coat method. The amount of coating was 8.4 cc/m², and drying was performed at 145° C. for one minute. With this, the first transparent layer having an average film thickness of approximately 0.1 μm was formed on a side opposite to the surface where the easily-adhesive layer was formed.

[Coating Fluid 1 for First Transparent Layer]

| | |
|---|---|
| Self-crosslinking polyurethane resin binder | 35.0 parts by mass |
| (Manufactured by Mitsui Chemicals Inc., | |
| TAKELAC WS-5100, solid content of 30%) | |
| Tin dioxide-antimony-combined acicular | 43.7 parts by mass |
| metal oxide water dispersion (Manufactured | |
| by Ishihara Sangyo Kaisha Ltd., FS-10D, | |
| solid content of 20%) | |
| Surface active agent C | 2.1 parts by mass |
| (Manufactured by Sanyo Chemical | |
| Industries, Ltd., 10% aqueous solution of | |
| Sanded BL, anionic) | |
| Surface active agent B | 21.0 parts by mass |
| (Manufactured by Sanyo Chemical | |
| Industries, Ltd., 1% aqueous solution | |
| of Naroacty CL-95, nonionic) | |
| Distilled Water | added so as to achieve 1000 |
| | parts by mass in total |

[Second Transparent Layer]

Subsequently, a coating fluid for the second transparent layer formed of the composition described below was applied onto the first transparent layer by the bar coat method. The amount of coating was 7.1 cc/m², and drying was performed at 145° C. for one minute. With this, the second transparent layer having an average film thickness of approximately 0.7 μm was formed.

[Coating Fluid for Second Transparent Layer]

| | |
|---|---|
| Acetic-acid aqueous solution | 148.3 parts by mass |
| (Manufactured by Daicel Chemical Industries | |
| Ltd., 1% aqueous solution of industrial | |
| acetic acid) | |
| 3-glycidoxypropyltrimethoxysilane | 58.1 parts by mass |
| (Manufactured by Shin-Etsu Chemical Co., Ltd., | |
| KBE-403) | |
| Tetramethoxysilane | 67.3 parts by mass |
| (Manufactured by Shin-Etsu Chemical Co., Ltd., | |
| KBE-04) | |
| Colloidal silica | 591.4 parts by mass |
| (Manufactured by Nissan Chemical Industries | |
| Co., Ltd., SNOWTEX OS, solid content of 20%) | |
| Curing agent | 2.0 parts by mass |
| (Manufactured by Kawaken Fine Chemical Co., | |
| Ltd., Alumichelate A (W)) | |
| Surface active agent C | 17.7 parts by mass |
| (Manufactured by Sanyo Chemical Industries, | |
| Ltd., 10% aqueous solution of Sanded BL, | |
| anionic) | |
| Surface active agent B | 52.0 parts by mass |
| (Manufactured by Sanyo Chemical Industries, | |
| Ltd., 1% aqueous solution of Naroacty CL-95, | |
| nonionic) | |
| Acrylic resin fine particles | 14.1 parts by mass |
| (Manufactured by Soken Chemical & Engineering | |
| Co., Ltd., MX-150, average particle diameter | |
| of 1.5 μm) | |
| Distilled Water | added so as to achieve |
| | 1000 parts by |
| | mass in total |

Note that the coating fluid for the second transparent layer was prepared by the following method.

While the acetic-acid aqueous solution was being heavily stirred, 3-glycidoxypropyltrimethoxysilane was dropped into this acetic-acid aqueous solution for three minutes. Subsequently, tetraalkoxysilane was added to the acetic-acid aqueous solution while being heavily stirred for five minutes, and then stirring continued for two hours (this aqueous solution is referred to as an X fluid). The curing agent was added to colloidal silica, and stirring continued for two hours (this aqueous solution is referred to as a Y fluid). Also, the surface active agent, distilled water, and resin particles were added, and ultrasonic dispersion was performed for five minutes (this particle dispersion fluid is referred to as a Z fluid). The Y fluid, the surface active agent, the Z fluid, and distilled water were sequentially added to the X fluid.

[Lens Layer]

After the easily-adhesive layer and the first and second transparent layers were formed on the support, the coating fluid for the prism layer in the first embodiment was applied onto an easily-adhesive layer A side by the bar coat method with a #24 bar. Then, after drying was performed at 60° C. for three minutes, a mold having a prism layer pattern molded thereon as a lens layer was pressed onto a prism layer coating surface, which was radiated with UV light (a metal halide lamp UVL-1500M2 manufactured by Ushio Inc.) from a support side on a condition of 2000 mJ/cm², thereby curing the resin. By peeling off the support from the mold, a prism layer having a vertical angle of 90° C., a pitch of 50 μm, and a height of 28 μm was formed.

### Fourteenth Example

As a [coating fluid for the second transparent layer], in place of the one in the thirteenth example, a coating fluid for the second transparent layer formed of the composition described below was subsequently applied onto the first transparent layer by the bar coat method. The amount of coating was 9.4 cc/m², and drying was performed at 145° C. for one minute. With this, the second transparent layer having an average film thickness of approximately 0.9 μm was formed.

[Coating Fluid for Second Transparent Layer]

| | |
|---|---|
| Acetic-acid aqueous solution (Manufactured | 136.0 parts by mass |
| by Daicel Chemical Industries Ltd., 1% | |
| aqueous solution of industrial acetic acid) | |
| 3-glycidoxypropyltrimethoxysilane | 53.2 parts by mass |
| (Manufactured by Shin-Etsu Chemical Co., | |
| Ltd., KBE-403) | |
| Tetramethoxysilane | 61.8 parts by mass |
| (Manufactured by Shin-Etsu Chemical Co., | |
| Ltd., KBE-04) | |
| Colloidal silica | 542.4 parts by mass |
| (Manufactured by Nissan Chemical | |
| Industries Co., Ltd., SNOWTEX OS, | |
| solid content of 20%) | |
| Curing agent | 1.8 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical | |
| Industries, Ltd., 10% aqueous solution | |
| of Sanded BL, anionic) | |
| Surface active agent B | 60.0 parts by mass |
| (Manufactured by Sanyo Chemical | |
| Industries, Ltd., 1% aqueous solution | |
| of Naroacty CL-95, nonionic) | |
| Polystyrene resin fine particles | 6.2 parts by mass |
| (Manufactured by Soken Chemical & | |
| Engineering Co., Ltd., MP5000, | |
| average particle diameter of 0.4 μm) | |
| Polystyrene resin fine particles | 6.2 parts by mass |
| (Manufactured by Soken Chemical & | |
| Engineering Co., Ltd., SX130H, average | |
| particle diameter of 1.3 μm) | |
| Water-dispersing element of polystyrene | 31.2 parts by mass |
| resin fine particles (Manufactured by Zeon | |
| Corporation, Nippol UFN1008, solid content | |
| of 20%, average particle diameter of 1.8 μm) | |
| Distilled Water | added so as to achieve 1000 |
| | parts by mass in total |

### Fifteenth Example

As a [coating fluid for the second transparent layer], in place of the one in the thirteenth example, a coating fluid for the second transparent layer formed of the composition described below was subsequently applied on the first transparent layer by the bar coat method. The amount of coating was 28.2 cc/m², and drying was performed at 145° C. for two minutes. With this, the second transparent layer having an average film thickness of approximately 2.2 μm was formed.

[Coating Fluid for Second Transparent Layer]

| | |
|---|---|
| Acetic-acid aqueous solution | 136.0 parts by mass |
| (Manufactured by Daicel Chemical | |
| Industries Ltd., 1% aqueous solution of | |
| industrial acetic acid) | |
| 3-glycidoxypropyltrimethoxysilane | 53.2 parts by mass |
| (Manufactured by Shin-Etsu | |
| Chemical Co., Ltd., KBE-403) | |
| Tetramethoxysilane | 61.8 parts by mass |
| (Manufactured by Shin-Etsu | |
| Chemical Co., Ltd., KBE-04) | |
| Colloidal silica | 542.4 parts by mass |
| (Manufactured by Nissan Chemical | |
| Industries Co., Ltd., SNOWTEX OS, | |
| solid content of 20%) | |
| Curing agent | 1.8 parts by mass |
| (Manufactured by Kawaken Fine Chemical | |
| Co., Ltd., Alumichelatc A (W)) | |
| Surface active agent C | 20.6 parts by mass |
| (Manufactured by Sanyo Chemical | |
| Industries, Ltd., 10% aqueous solution of | |
| Sanded BL, anionic) | |
| Surface active agent B | 60.0 parts by mass |
| (Manufactured by Sanyo Chemical | |
| Industries, Ltd., 1% aqueous solution of | |
| Naroacty CL-95, nonionic) | |
| Acrylic resin fine particles | 10.7 parts by mass |
| (Manufactured by Soken Chemical & | |
| Engineering Co., Ltd., MX-300, average | |
| particle diameter of 3.0 μm) | |
| Distilled Water | added so as to achieve 1000 |
| | parts by mass in total |

### Sixteenth Example

As a [coating fluid for the second transparent layer], in place of the one in the thirteenth example, a coating fluid for the second transparent layer formed of the composition described below was subsequently applied on the first transparent layer by the bar coat method. The amount of coating was 7.8 cc/m², and drying was performed at 145° C. for one minute. With this, the second transparent layer having an average film thickness of approximately 0.8 μm was formed.

[Coating Fluid for Second Transparent Layer]

| | |
|---|---|
| Acetic-acid aqueous solution | 136.0 parts by mass |
| (Manufactured by Daicel Chemical | |
| Industries Ltd., 1% aqueous solution | |
| of industrial acetic acid) | |
| 3-glycidoxypropyltrimethoxysilane | 53.2 parts by mass |
| (Manufactured by Shin-Etsu Chemical Co., | |
| Ltd., KBE-403) | |
| Tetramethoxysilane | 61.8 parts by mass |
| (Manufactured by Shin-Etsu Chemical | |
| Co., Ltd., KBE-04) | |
| Colloidal silica | 542.4 parts by mass |
| (Manufactured by Nissan Chemical | |
| Industries Co., Ltd., SNOWTEX OS, solid | |
| content of 20%) | |
| Curing agent | 1.8 parts by mass |
| (Manufactured by Kawaken Fine | |
| Chemical Co., Ltd., Alumichelate A (W)) | |
| Surface active agent C | 20.6 parts by mass |
| (Manufactured by Sanyo Chemical | |
| Industries, Ltd., 10% aqueous solution | |
| of Sanded BL, anionic) | |
| Surface active agent B | 60.0 parts by mass |
| (Manufactured by Sanyo Chemical | |
| Industries, Ltd., 1% aqueous solution | |
| of Naroacty CL-95, nonionic) | |
| Acrylic resin fine particles | 4.3 parts by mass |
| (Manufactured by Soken Chemical & | |
| Engineering Co., Ltd., MX80H3WT, | |
| average particle diameter of 0.8 μm) | |
| Acrylic resin fine particles | 4.3 parts by mass |
| (Manufactured by Soken Chemical & | |
| Engineering Co., Ltd., MX-150, | |
| average particle diameter of 1.5 μm) | |
| Acrylic resin fine particles | 4.3 parts by mass |
| (Manufactured by Soken Chemical & | |
| Engineering Co., Ltd., MX-180, average | |
| particle diameter of 1.8 μm) | |
| Distilled Water | added so as to achieve 1000 |
| | parts by mass in total |

### Seventeenth Example

As a [coating fluid for the second transparent layer], in place of the one in the thirteenth example, a coating fluid for the second transparent layer formed of the composition described below was subsequently applied on the first transparent layer by the bar coat method. The amount of coating was 3.4 cc/m², and drying was performed at 145° C. for one minute. With this, the second transparent layer having an average film thickness of approximately 0.7 μm was formed.

| | |
|---|---|
| MEK (methyl ethyl ketone) | 800.0 parts by mass |
| Polyfunctional acrylic monomer (Manufactured by | 186 parts by mass |
| Nippon Kayaku Co., Ltd., KAYARAD DPCA20) | |
| Acrylic resin fine particles | 8.5 parts by mass |
| (Manufactured by Soken Chemical & Engineering | |
| Co., Ltd., MX-180, average particle diameter | |
| of 1.8 μm) | |
| Ultraviolet curing resin | 5.5 parts by mass |
| (Manufactured by Ciba Specialty Chemicals Inc., | |
| Irg184) | |

This fluid was stirred for use after mixing.

After coating, drying was performed at 60° C. for one minute, and then UV light (a metal halide lamp UVL-1500M2 manufactured by Ushio Inc.) was applied from a coating surface side on a condition of 2000 mJ/cm², thereby curing the resin.

### Eighteenth Example

As a [coating fluid for the second transparent layer], in place of the one in the thirteenth example, a coating fluid for the second transparent layer formed of the composition described below was subsequently applied on the first transparent layer by the bar coat method. The amount of coating was 10.4 cc/m², and drying was performed at 145° C. for one minute. With this, the second transparent layer having an average film thickness of approximately 1.2 μm was formed.

[Coating Fluid for Second Transparent Layer]

| | |
|---|---|
| Acetic-acid aqueous solution | 144.3 parts by mass |
| (Manufactured by Daicel Chemical | |
| Industries Ltd., 1% aqueous solution | |
| of industrial acetic acid) | |
| 3-glycidoxypropyltrimethoxysilane | 56.5 parts by mass |
| (Manufactured by Shin-Etsu Chemical | |
| Co., Ltd., KBE-403) | |
| Tetramethoxysilane | 65.5 parts by mass |
| (Manufactured by Shin-Etsu Chemical | |
| Co., Ltd., KBE-04) | |
| Colloidal silica | 575.1 parts by mass |
| (Manufactured by Nissan Chemical | |
| Industries Co., Ltd., SNOWTEX OS, | |
| solid content of 20%) | |
| Curing agent | 1.9 parts by mass |
| (Manufactured by Kawaken Fine | |
| Chemical Co., Ltd., Alumichelate A (W)) | |
| Surface active agent C | 20.6 parts by mass |
| (Manufactured by Sanyo Chemical | |
| Industries, Ltd., 10% aqueous solution | |
| of Sanded BL, anionic) | |
| Surface active agent B | 57.2 parts by mass |
| (Manufactured by Sanyo Chemical | |
| Industries, Ltd., 1% aqueous solution | |
| of Naroacty CL-95, nonionic) | |
| Water-dispersing element of | 87.0 parts by mass |
| polystyrene resin fine particles | |
| (Manufactured by Zeon Corporation, Nippol | |
| UFN1008, solid content of 20%, average | |
| particle diameter of 1.8 μm) | |
| Distilled Water | added so as to achieve 1000 |
| | parts by mass in total |

### Nineteenth Example

As a [coating fluid for the second transparent layer], in place of the one in the thirteenth example, a coating fluid for the second transparent layer formed of the composition below was subsequently applied on the first transparent layer by the bar coat method. The amount of coating was 10.4 cc/m², and drying was performed at 145° C. for one minute. With this, the second transparent layer having an average film thickness of approximately 1.0 μm was formed.

### [Coating Fluid for Second Transparent Layer]

| | |
|---|---|
| Acetic-acid aqueous solution | 122.5 parts by mass |
| (Manufactured by Daicel Chemical | |
| Industries Ltd., 1% aqueous solution of | |
| industrial acetic acid) | |
| 3-glycidoxypropyltrimethoxysilane | 48.0 parts by mass |
| (Manufactured by Shin-Etsu Chemical Co., | |
| Ltd., KBE-403) | |
| Tetramethoxysilane | 55.6 parts by mass |
| (Manufactured by Shin-Etsu Chemical Co., | |
| Ltd., KBE-04) | |
| Colloidal silica | 488.9 parts by mass |
| (Manufactured by Nissan Chemical | |
| Industries Co., Ltd., SNOWTEX OS, | |
| solid content of 20%) | |
| Curing agent | 1.6 parts by mass |
| (Manufactured by Kawaken Fine | |
| Chemical Co., Ltd., Alumichelate A (W)) | |
| Surface active agent C | 18.6 parts by mass |
| (Manufactured by Sanyo Chemical | |
| Industries, Ltd., 10% aqueous | |
| solution of Sanded BL, anionic) | |
| Surface active agent B | 60.2 parts by mass |
| (Manufactured by Sanyo Chemical | |
| Industries, Ltd., 1% aqueous solution | |
| of Naroacty CL-95, nonionic) | |
| Acrylic resin fine particles | 7.2 parts by mass |
| (Manufactured by Soken Chemical & | |
| Engineering Co., Ltd., MX80H3WT, | |
| average particle diameter of 0.8 μm) | |
| Polystyrene resin fine particles | 7.2 parts by mass |
| (Manufactured by Soken Chemical & | |
| Engineering Co., Ltd., SX130H, | |
| average particle diameter of 1.3 μm) | |
| Water-dispersing element of | 36.0 parts by mass |
| polystyrene resin fine particles | |
| (Manufactured by Zeon Corporation, | |
| Nippol UFN1008, solid content of 20%, | |
| average particle diameter of 1.8 μm) | |
| Distilled Water | added so as to achieve 1000 |
| | parts by mass in total |

### Twentieth Example>

As a [coating fluid for the second transparent layer], in place of the one in the thirteenth example, a coating fluid for the second transparent layer formed of the composition below was subsequently applied on the first transparent layer by the bar coat method. The amount of coating was 10.4 cc/m², and drying was performed at 145° C. for one minute. With this, the second transparent layer having an average film thickness of approximately 1.0 μm was formed.

### [Coating Fluid for Second Transparent Layer]

| | |
|---|---|
| Acetic-acid aqueous solution | 122.5 parts by mass |
| (Manufactured by Daicel Chemical | |
| Industries Ltd., 1% aqueous solution of | |
| industrial acetic acid) | |
| 3-glycidoxypropyltrimethoxysilane | 48.0 parts by mass |
| (Manufactured by Shin-Etsu Chemical Co., | |
| Ltd., KBE-403) | |
| Tetramethoxysilane | 55.6 parts by mass |
| (Manufactured by Shin-Etsu Chemical Co., | |
| Ltd., KBE-04) | |
| Colloidal silica | 488.9 parts by mass |
| (Manufactured by Nissan Chemical | |
| Industries Co., Ltd., SNOWTEX OS, | |
| solid content of 20%) | |
| Curing agent | 1.6 parts by mass |
| (Manufactured by Kawaken Fine Chemical | |
| Co., Ltd., Alumichelate A (W)) | |
| Surface active agent C | 18.6 parts by mass |
| (Manufactured by Sanyo Chemical | |
| Industries, Ltd., 10% aqueous solution of | |
| Sanded BL, anionic) | |
| Surface active agent B | 60.2 parts by mass |
| (Manufactured by Sanyo Chemical | |
| Industries, Ltd., 1% aqueous solution of | |
| Naroacty CL-95, nonionic) | |
| Acrylic resin fine particles | 7.2 parts by mass |
| (Manufactured by Soken Chemical & | |
| Engineering Co., Ltd., MX80H3WT, | |
| average particle diameter of 0.8 μm) | |
| Acrylic resin fine particles | 7.2 parts by mass |
| (Manufactured by Soken Chemical & | |
| Engineering Co., Ltd., MX150, | |
| average particle diameter of 1.5 μm) | |
| Water-dispersing element of polystyrene | 36.0 parts by mass |
| resin fine particles (Manufactured by | |
| Zeon Corporation, Nippol UFN1008, | |
| solid content of 20%, average particle | |
| diameter of 1.8 μm) | |
| Distilled Water | added so as to achieve 1000 |
| | parts by mass in total |

### Twenty-First Example

As a [coating fluid for the second transparent layer], in place of the one in the thirteenth example, a coating fluid for the second transparent layer formed of the composition below was subsequently applied on the first transparent layer by the bar coat method. The amount of coating was 2.2 cc/m², and drying was performed at 145° C. for one minute. With this, the second transparent layer having an average film thickness of approximately 0.2 μm was formed.

[Coating Fluid for Second Transparent Layer]

| | |
|---|---|
| Acetic-acid aqueous solution | 136.7 parts by mass |
| (Manufactured by Daicel Chemical | |
| Industries Ltd., 1% aqueous solution of | |
| industrial acetic acid) | |
| 3-glycidoxypropyltrimethoxysilane | 53.5 parts by mass |
| (Manufactured by Shin-Etsu Chemical Co., | |
| Ltd., KBE-403) | |
| Tetramethoxysilane | 62.0 parts by mass |
| (Manufactured by Shin-Etsu Chemical Co., | |
| Ltd., KBE-04) | |
| Colloidal silica | 545.3 parts by mass |
| (Manufactured by Nissan Chemical | |
| Industries Co., Ltd., SNOWTEX OS, | |
| solid content of 20%) | |
| Curing agent | 1.8 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical | |
| Industries, Ltd., 10% aqueous solution of | |
| Sanded BL, anionic) | |
| Surface active agent B | 60.0 parts by mass |
| (Manufactured by Sanyo Chemical | |
| Industries, Ltd., 1% aqueous solution of | |
| Naroacty CL-95, nonionic) | |
| Polystyrene resin fine particles | 91.0 parts by mass |
| (Manufactured by Soken Chemical & | |
| Engineering Co., Ltd., MP5000, average | |
| particle diameter of 0.4 μm) | |
| Distilled Water | added so as to achieve 1000 |
| | parts by mass in total |

### Twenty-Second Example

As a [coating fluid for the second transparent layer], in place of the one in the thirteenth example, a coating fluid for the second transparent layer formed the composition described below was subsequently applied on the first transparent layer by the bar coat method. The amount of coating was 26.6 cc/m², and drying was performed at 145° C. for two minutes. With this, the second transparent layer having an average film thickness of approximately 2.4 μm was formed.

### [Coating Fluid for Second Transparent Layer]

| | |
|---|---|
| Acetic-acid aqueous solution | 136.0 parts by mass |
| (Manufactured by Daicel Chemical | |
| Industries Ltd., 1% aqueous solution of | |
| industrial acetic acid) | |
| 3-glycidoxypropyltrimethoxysilane | 53.2 parts by mass |
| (Manufactured by Shin-Etsu Chemical Co., | |
| Ltd., KBE-403) | |
| Tetramethoxysilane | 61.8 parts by mass |
| (Manufactured by Shin-Etsu Chemical Co., | |
| Ltd., KBE-04) | |
| Colloidal silica | 542.4 parts by mass |
| (Manufactured by Nissan Chemical | |
| Industries Co., Ltd., SNOWTEX OS, | |
| solid content of 20%) | |
| Curing agent | 1.8 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical | |
| Industries, Ltd., 10% aqueous solution of | |
| Sanded BL, anionic) | |
| Surface active agent B | 70.0 parts by mass |
| (Manufactured by Sanyo Chemical | |
| Industries, Ltd., 1% aqueous solution of | |
| Naroacty CL-95, nonionic) | |
| Acrylic resin fine particles | 18.7 parts by mass |
| (Manufactured by Soken Chemical & | |
| Engineering Co., Ltd., MX-300, | |
| average particle diameter of 3.0 μm) | |
| Distilled Water | added so as to achieve 1000 |
| | parts by mass in total |

### Twenty-Third Example

As a [coating fluid for the second transparent layer], in place of the one in the thirteenth example, a coating fluid for the second transparent layer formed of the composition described below was subsequently applied on the first transparent layer by the bar coat method. The amount of coating was 1.0 cc/m², and drying was performed at 145° C. for one minute. With this, the second transparent layer having an average film thickness of approximately 0.1 μma was formed.

| | |
|---|---|
| MEK (methyl ethyl ketone) | 868.2 parts by mass |
| Polyfunctional acrylic monomer (Manufactured by | 60.0 parts by mass |
| Nippon Kayaku Co., Ltd., KAYARAD DPCA20) | |
| Acrylic resin fine particles | 70.0 parts by mass |
| (Manufactured by Soken Chemical & Engineering | |
| Co., Ltd., MX80H3WT, average | |
| particle diameter of 0.8 μm) | |
| Ultraviolet curing resin | 1.8 parts by mass |
| (Manufactured by Ciba Specialty Chemicals Inc., | |
| Irg184) | |

After mixing, this fluid was agitated for use.

After coating, drying was performed at 60° C. for one minute, and then UV light (a metal halide lamp UVL-1500M2 manufactured by Ushio Inc.) was applied from a coating surface side on a condition of 2000 mJ/cm², thereby curing the resin.

### Twenty-Fourth Example

As a [coating fluid for the second transparent layer], in place of the one in the thirteenth example, a coating fluid for the second transparent layer formed of the composition described below was subsequently applied on the first transparent layer by the bar coat method. The amount of coating was 13.0 cc/m², and drying was performed at 145° C. for one minute. With this, the second transparent layer having an average film thickness of approximately 1.3 μm was formed.

| | |
|---|---|
| MEK (methyl ethyl ketone) | 868.2 parts by mass |
| Polyfunctional acrylic monomer (Manufactured by | 60.0 parts by mass |
| Nippon Kayaku Co., Ltd., KAYARAD DPCA20) | |
| Acrylic resin fine particles | 14.0 parts by mass |
| (Manufactured by Soken Chemical & Engineering | |
| Co., Ltd., MX80H3WT, average | |
| particle diameter of 0.8 μm) | |
| Ultraviolet curing resin | 1.8 parts by mass |
| (Manufactured by Ciba Specialty Chemicals Inc., | |
| Irg184) | |

After mixing, this fluid was agitated for use.

After coating, drying was performed at 60° C. for one minute, and then UV light (a metal halide lamp UVL-1500M2 manufactured by Ushio Inc.) was applied from a coating surface side on a condition of 2000 mJ/cm², thereby curing the resin.

### Fifth Comparative Example

As a [coating fluid for the second transparent layer], in place of the one in the thirteenth example, a coating fluid for the second transparent layer formed the composition described below was subsequently applied on the first transparent layer by the bar coat method. The amount of coating was 14.2 cc/m², and drying was performed at 145° C. for two minutes. With this, the second transparent layer having an average film thickness of approximately 1.4 μm was formed.

[Coating Fluid for Second Transparent Layer]

| | |
|---|---|
| Acetic-acid aqueous solution | 136.0 parts by mass |
| (Manufactured by Daicel Chemical | |
| Industries Ltd., 1% aqueous solution of | |
| industrial acetic acid) | |
| 3-glycidoxypropyltrimethoxysilane | 53.2 parts by mass |
| (Manufactured by Shin-Etsu Chemical Co., | |
| Ltd., KBE-403) | |
| Tetramethoxysilane | 61.8 parts by mass |
| (Manufactured by Shin-Etsu Chemical Co., | |
| Ltd., KBE-04) | |
| Colloidal silica | 542.4 parts by mass |
| (Manufactured by Nissan Chemical | |
| Industries Co., Ltd., SNOWTEX OS, | |
| solid content of 20%) | |
| Curing agent | 1.8 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical | |
| Industries, Ltd., 10% aqueous solution of | |
| Sanded BL, anionic) | |
| Surface active agent B | 60.0 parts by mass |
| (Manufactured by Sanyo Chemical | |
| Industries, Ltd., 1% aqueous solution of | |
| Naroacty CL-95, nonionic) | |
| Acrylic resin fine particles | 3.6 parts by mass |
| (Manufactured by Soken Chemical & | |
| Engineering Co., Ltd., MX-300, average | |
| particle diameter of 3.0 μm) | |
| Distilled Water | added so as to achieve 1000 |
| | parts by mass in total |

### Sixth Comparative Example

As a [coating fluid for the second transparent layer], in place of the one in the thirteenth example, a coating fluid for the second transparent layer formed the composition described below was subsequently applied on the first transparent layer by the bar coat method. The amount of coating was 24.3 cc/m², and drying was performed at 145° C. for two minutes. With this, the second transparent layer having an average film thickness of approximately 2.3 μm was formed.

### [Coating Fluid for Second Transparent Layer]

| | |
|---|---|
| Acetic-acid aqueous solution | 136.1 parts by mass |
| (Manufactured by Daicel Chemical | |
| Industries Ltd., 1% aqueous solution of | |
| industrial acetic acid) | |
| 3-glycidoxypropyltrimethoxysilane | 53.3 parts by mass |
| (Manufactured by Shin-Etsu Chemical Co., | |
| Ltd., KBE-403) | |
| Tetramethoxysilane | 61.3 parts by mass |
| (Manufactured by Shin-Etsu Chemical Co., | |
| Ltd., KBE-04) | |
| Colloidal silica | 543.1 parts by mass |
| (Manufactured by Nissan Chemical | |
| Industries Co., Ltd., SNOWTEX OS, | |
| solid content of 20%) | |
| Curing agent | 1.8 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical | |
| Industries, Ltd., 10% aqueous solution of | |
| Sanded BL, anionic) | |
| Surface active agent B | 60.0 parts by mass |
| (Manufactured by Sanyo Chemical | |
| Industries, Ltd., 1% aqueous solution of | |
| Naroacty CL-95, nonionic) | |
| Acrylic resin fine particles | 29.0 parts by mass |
| (Manufactured by Soken Chemical & | |
| Engineering Co., Ltd., MX-300, average | |
| particle diameter of 3.0 μm) | |
| Distilled Water | added so as to achieve 1000 |
| | parts by mass in total |

### Seventh Comparative Example

As a [coating fluid for the second transparent layer], in place of the one in the thirteenth example, a coating fluid for the second transparent layer formed the composition described below was subsequently applied on the first transparent layer by the bar coat method. The amount of coating was 2.2 cc/m², and drying was performed at 145° C. for two minutes. With this, the second transparent layer having an average film thickness of approximately 0.2 μm was formed.

[Coating Fluid for Second Transparent Layer]

| | |
|---|---|
| Acetic-acid aqueous solution | 136.7 parts by mass |
| (Manufactured by Daicel Chemical | |
| Industries Ltd., 1% aqueous solution of | |
| industrial acetic acid) | |
| 3-glycidoxypropyltrimethoxysilane | 53.5 parts by mass |
| (Manufactured by Shin-Etsu Chemical Co., | |
| Ltd., KBE-403) | |
| Tetramethoxysilane | 62.1 parts by mass |
| (Manufactured by Shin-Etsu Chemical Co., | |
| Ltd., KBE-04) | |
| Colloidal silica | 545.3 parts by mass |
| (Manufactured by Nissan Chemical | |
| Industries Co., Ltd., SNOWTEX OS, | |
| solid content of 20%) | |
| Curing agent | 1.8 parts by mass |
| (Manufactured by Kawaken Fine Chemical | |
| Co., Ltd., Alumichelate A (W)) | |
| Surface active agent C | 20.6 parts by mass |
| (Manufactured by Sanyo Chemical | |
| Industries, Ltd., 10% aqueous solution of | |
| Sanded BL, anionic) | |
| Surface active agent B | 60.0 parts by mass |
| (Manufactured by Sanyo Chemical | |
| Industries, Ltd., 1% aqueous solution of | |
| Naroacty CL-95, nonionic) | |
| Acrylic resin fine particles | 32.0 parts by mass |
| (Manufactured by Soken Chemical & | |
| Engineering Co., Ltd., MX-150, average | |
| particle diameter of 1.5 μm) | |
| Distilled Water | added so as to achieve 1000 |
| | parts by mass in total |

### Eighth Comparative Example

As a [coating fluid for the second transparent layer], in place of the one in the thirteenth example, a coating fluid for the second transparent layer formed of the composition described below was subsequently applied on the first transparent layer by the bar coat method. The amount of coating was 32.0 cc/m², and drying was performed at 145° C. for two minutes. With this, the second transparent layer having an average film thickness of approximately 8 μm was formed.

[Coating Fluid for Second Transparent Layer]

| | |
|---|---|
| Surface active agent | 1.8 parts by mass |
| (Manufactured by Sanyo Chemical | |
| Industries, Ltd., Naroacty CL-95) | |
| Polystyrene fine particles | 12.3 parts by mass |
| (Manufactured by Sekisui Plastics Co., | |
| Ltd., SBX-4, polystyrene particles, | |
| average particle diameter of 4 μm) | |
| Water-dispersing polymer | 708.0 parts by mass |
| (polyurethane resin, manufactured by Mitsui | |
| Chemicals Inc., TAKELAC W6010, solid | |
| content of 30%) | |
| Crosslinking agent | 44.2 parts by mass |
| (Manufactured by Nisshinbo Chemical, Inc., | |
| CARBODILITE V-02-L2, solid content of | |
| 40%) | |
| Distilled Water | added so as to achieve 1000 |
| | parts by mass in total |

This fluid was stirred for use after mixing.

[Evaluation]

The optical laminate films obtained in the thirteenth to twenty-fourth examples and the fifth to eighth comparative examples were evaluated as follows.

[Haze Value]

In the examples of the optical laminate film 10, a haze meter (NDH-2000, Nippon Denshoku Industries Co., Ltd.) was used, and hazes were measured according to JIS-K-7105.

Note that in the examples of the optical laminate film 20, a measurement can be performed with the film being completely flattened with a fluid having a refractive index equal to that of the lens layer (such as matching oil).

[Volume Average Particle Diameter]

With an optical microscope, a diameter Di of each of particles and the number of particles ni were measured within a range of 1 cm², and a volume average particle r was calculated as r=Σ(Di×Di³×ni)/E(Di³×ni).

Also, when a measurement with the optical microscope was difficult, a SEM or the like was used as appropriate to calculate a particle diameter from images of the surface and section of the film.

[Amount of Addition of Translucent Particles]

Measurements were performed with a method similar to that for measuring a volume average particle diameter. With a relative density of each particle being taken as Ai, the amount of addition was calculated as S (mg)=10×4π/3×Σ{Ai×ni×(Di/2)³}.

[Average Film Thickness of Transparent Layer]

A sectional photograph of the film was shot by SEM with the number of items allowing the film thickness to be measured without variation, the thickness of each part was measured, and the obtained values were averaged to find an average film thickness.

[10-Point Average Roughness]

10-point average roughness (Rz) was set by using a stylus-type surface roughness measuring instrument “HANDY SURF E-35B” (manufactured by Tokyo Seimitsu Co., Ltd.) according to JIS B-0601 (1994), and values derived from the surface roughness measuring instrument were adopted.

### [Rainbow-Like Unevenness]

The backlight of BRAVIA (KDL-40NX800) manufactured by SONY Corporation was taken out so that the backlight can be lit up, and each sample was arranged on the backlight, with the prism layer being placed outside. Then, evaluation was visually made as to the degree of color unevenness in a boundary region between a bright part and a dark part viewed in a direction perpendicular to a direction in which the prisms of the prism layer is on a line and when a line of sight is titled at approximately

30° from a straight above direction.
A: Little unevenness can be viewed.
B: Slight unevenness can be viewed.
C: Significant unevenness can be viewed.

[Particle Missing]

With an abrasion-resistance test machine (manufactured by SHINTO Scientific Co., Ltd.), missing or falling of particles were evaluated. Specifically, black paper (manufactured by FUJI FILM Corporation, SKBT 3 90BIG0) was brought into contact with a coating surface on a back surface side and, with a load of 3 kg per 30 mm×25 mm being applied, the surface was rubbed for a distance of 10 cm at 100 cm/minute. After the rubbing test, a level of white powder attached onto the black paper was visually evaluated.

A: A trace amount of white powder or none is attached.
B: A slight amount of white powder is attached
C: A significant amount of white powder is attached

Table 2 summarizes conditions and evaluation results of examples and comparative examples. In the thirteenth to twenty-fourth examples, since the volume average particle diameter r of the translucent particles satisfies 0.4 μm≦r≦3.0 μm, the total sum S satisfies 30 mg/m²≦S≦500 mg/m², and the 10-point average roughness Rz satisfies 0.5 μm≦Rz≦1.0 μm, evaluations of rainbow-like unevenness and particle missing were B or higher.

In the fifth comparative example, the addition amount of particles is smaller than 30 mg/m² and Rz is larger than 1.0 μm, evaluation of rainbow-like unevenness is marked with C. In the sixth comparative example, since the addition amount S of transparent particles is large, particle missing is marked with C. In the seventh comparative example, since the addition amount of the particles is larger than 500 mg/m² and Rz is larger than 1.0 μm, particle missing is marked with C. In the eighth comparative example, the average particle diameter r is larger than 3.0 μm and Rz is smaller than 0.5 μm even with a haze value of 31%, and therefore rainbow-like unevenness is marked with C.

TABLE 2

| | | VOLUME | AMOUNT OF | 10-POINT | | |
|---|---|---|---|---|---|---|
| | HAZE | AVERAGE | ADDITION OF | AVERAGE | | |
| | VALUE | PARTICLE | PARTICLES | ROUGHNESS | RAINBOW-LIKE | PARTICLE |
| | (%) | DIAMETER (μm) | (mg/m²) | (μm) | UNEVENNESS | MISSING |
| EXAMPLE 13 | 35 | 1.5 | 100 | 0.8 | A | A |
| EXAMPLE 14 | 42 | 1.1 | 180 | 0.7 | A | A |
| EXAMPLE 15 | 40 | 3 | 300 | 0.8 | A | A |
| EXAMPLE 16 | 29 | 1.4 | 100 | 0.9 | A | A |
| EXAMPLE 17 | 20 | 1.5 | 30 | 0.9 | A | A |
| EXAMPLE 18 | 43 | 1.8 | 180 | 0.5 | B | A |
| EXAMPLE 19 | 43 | 1.3 | 225 | 0.6 | A | A |
| EXAMPLE 20 | 40 | 1.4 | 225 | 0.7 | A | A |
| EXAMPLE 21 | 55 | 0.4 | 200 | 0.7 | B | A |
| EXAMPLE 22 | 60 | 3 | 500 | 0.8 | A | B |
| EXAMPLE 23 | 30 | 0.8 | 70 | 0.7 | A | B |
| EXAMPLE 24 | 35 | 0.8 | 180 | 0.7 | A | A |
| COMPARATIVE | 11 | 3 | 25 | 1.4 | C | A |
| EXAMPLE 5 | | | | | | |
| COMPARATIVE | −90 | 3 | 700 | −0.9 | A | C |
| EXAMPLE 6 | | | | | | |
| COMPARATIVE | −40 | 1.5 | 700 | −1.2 | A | C |
| EXAMPLE 7 | | | | | | |
| COMPARATIVE | 31 | 4 | 400 | 0.3 | C | A |
| EXAMPLE 8 | | | | | | |

What is claimed is:

1. An optical laminate film comprising:
a support;
an easily-adhesive layer provided on one surface of the support; and
a transparent layer made of translucent resin provided on another surface of the support, wherein
the transparent layer contains translucent particles,
a volume average particle diameter r of the translucent particles satisfies 0.4 μm≦r≦3.0 μm,
a total sum S of the translucent particles satisfies 30 mg/m²≦S≦500 mg/m², and
an average film thickness t of the transparent layer satisfies r/4≦t<r.

2. The optical laminate film according to claim 1, wherein a haze value of the optical laminate film is equal to or larger than 20% and equal to or smaller than 60%.

3. The optical laminate film according to claim 1, wherein the transparent layer is formed of two layers including, from a side close to the support, a first transparent layer and a second transparent layer.

4. The optical laminate film according to claim 1, wherein
the transparent layer includes either one of metal oxide particles exhibiting conductivity by electron conduction and a π electron-conjugated conductive polymer, and
the transparent layer has a surface resistance equal to or lower than 10¹² Ω/sq.

5. The optical laminate film according to claim 1, wherein
the easily-adhesive layer includes either one of metal oxide particles exhibiting conductivity by electron conduction and a π electron-conjugated conductive polymer, and
the easily-adhesive layer has a surface resistance equal to or lower than 10¹² Ω/sq.

6. The optical laminate film according to claim 1, further comprising
a lens layer provided on the easily-adhesive layer.

7. The optical laminate film according to claim 1, wherein the transparent layer has a 10-point average roughness Rz of 0.5 μm≦Rz≦1.0 μm.

8. A display device comprising the optical laminate film according to claim 1 which is mounted thereon.

9. An optical laminate film comprising:
a support;
an easily-adhesive layer provided on one surface of the support; and
a transparent layer made of translucent resin provided on another surface of the support, wherein
the transparent layer contains translucent particles,
a volume average particle diameter r of the translucent particles satisfies 0.4 μm≦r≦3.0 μm,
a total sum S of the translucent particles satisfies 30 mg/m²≦S≦500 mg/m², and
a 10-point average roughness Rz of the transparent layer satisfies 0.5 μm≦Rz≦1.0 μm.

10. The optical laminate film according to claim 9, wherein a haze value of the optical laminate film is equal to or larger than 20% and equal to or smaller than 60%.

11. The optical laminate film according to claim 9, wherein the transparent layer is formed of two layers including, from a side close to the support, a first transparent layer and a second transparent layer.

12. The optical laminate film according to claim 9, wherein
the transparent layer includes either one of metal oxide particles exhibiting conductivity by electron conduction and a it electron-conjugated conductive polymer, and
the transparent layer has a surface resistance equal to or lower than 10¹² Ω/sq.

13. The optical laminate film according to claim 9, wherein
the easily-adhesive layer includes either one of metal oxide particles exhibiting conductivity by electron conduction and a π electron-conjugated conductive polymer, and
the easily-adhesive layer has a surface resistance equal to or lower than 10¹² Ω/sq.

14. The optical laminate film according to claim 9, further comprising
a lens layer provided on the easily-adhesive layer.

15. A display device comprising the optical laminate film according to claim 9 which is mounted thereon.
